(19) United States
(12) Patent Application Publication
(10) Pub. No.: US 2021/0080759 A1
(43) Pub. Date: Mar. 18, 2021

(54) STACKED LIQUID CRYSTAL STRUCTURES

(71) Applicant: Facebook Technologies, LLC, Menlo Park, CA (US)

(72) Inventors: Yang Zhao, Kirkland, WA (US); Fenglin Peng, Redmond, WA (US); Junren Wang, Redmond, WA (US); Afsoon Jamali, Redmond, WA (US); Lu Lu, Kirkland, WA (US); Douglas Robert Lanman, Bellevue, WA (US)

(21) Appl. No.: 16/733,705

(22) Filed: Jan. 3, 2020

Related U.S. Application Data
(60) Provisional application No. 62/900,123, filed on Sep. 13, 2019.

(51) Int. Cl. G02F 1/01; G02F 1/139; G02F 1/1347; G02F 1/1343

(52) U.S. Cl. CPC G02F 1/0136; G02F 1/1393; G02F 2201/16; G02F 1/134309; G02F 1/13439; G02F 1/1347

(57) ABSTRACT

A first type of stacked LC structure includes at least two liquid crystal (LC) cells arranged in optical series that share a common substrate between adjacent LC cells. A second type of stacked LC structure includes at least two LC cells arranged in optical series that share a common electrode layer between adjacent LC cells. An optical assembly for use in a head mounted display (HMD) may include one or more stacked LC structures configured to transmit light in successive optical stages to provide a varifocal optical display assembly having adjustable optical power. By sharing a common substrate or a common electrode layer between adjacent LC cells, the total thickness of a stacked LC structure may be reduced, which may lead to a corresponding reduction in size and weight and improvement in user comfort for an HMD.

This application claims the benefit of U.S. Provisional Application No. 62/900,123, filed Sep. 13, 2019, the entire content of which is incorporated by reference herein.

### BACKGROUND

Artificial reality systems have applications in many fields such as computer gaming, health and safety, industry, and education. As a few examples, artificial reality systems are being incorporated into mobile devices, gaming consoles, personal computers, movie theaters, and theme parks. In general, artificial reality is a form of reality that has been adjusted in some manner before presentation to a user, which may include, e.g., a virtual reality, an augmented reality, a mixed reality, a hybrid reality, or some combination and/or derivatives thereof.

Typical artificial reality systems include one or more devices for rendering and displaying content to users. As one example, an artificial reality system may incorporate a head-mounted display (HMD) worn by a user and configured to output artificial reality content to the user. The artificial reality content may entirely consist of content that is generated by the system or may include generated content combined with real-world content (e.g., pass through views or captured real-world video and/or images of a user's physical environment). During operation, the user typically interacts with the artificial reality system to select content, launch applications, configure the system and, in general, experience artificial reality environments.

### SUMMARY

In general, the disclosure describes stacked liquid crystal (LC) structures that may be integrated into an optical assembly of a head mounted display. In accordance with some examples, the disclosure is directed to a stacked liquid crystal (LC) structure comprising a bottom substrate; a common substrate; a top substrate; a first LC cell disposed between the bottom substrate and the common substrate; a second LC cell disposed between the common substrate and the top substrate, wherein the common substrate includes or is coated with at least one electrically conductive layer that acts as an electrode for at least one of the two LC cells, wherein the stacked LC structure is configurable to be in a first state or a second state, wherein in the first state, the stacked LC structure converts incident light of a first polarization into light of a second polarization; and in the second state, the stacked LC structure transmits incident light without changing polarization of the incident light.

The common substrate may include an input surface and an output surface, and the common substrate may include a first electrically conductive layer disposed on the input surface that acts as an electrode for the first LC cell, and a second electrically conductive layer disposed on the output surface that acts as an electrode for the second LC cell. The bottom substrate may include a third electrically conductive layer adjacent to the first LC cell and the top substrate may include a fourth electrically conductive layer adjacent to the second LC cell, and wherein the first and third electrically conductive layers act as an electrode pair for the first LC cell and the second and fourth electrically conductive layers as an electrode pair for the second LC cell.

The stacked LC structure may be configurable to be in the first state or the second state by application of a voltage to the at least one electrically conductive layer. The first state may be associated with application of a first voltage to the at least one electrically conductive layer and the second state may be associated with application of a second voltage to the at least one electrically conductive layer, wherein the first voltage is different than the second voltage.

In accordance with other examples, the disclosure is directed to a stacked liquid crystal (LC) structure comprising a bottom substrate; a top substrate; a common electrically conductive layer; a first LC cell disposed between an output surface of the bottom substrate and the common electrically conductive layer; and a second LC cell disposed between an input surface of the top substrate and the common electrically conductive layer; wherein the stacked LC structure is configurable to be in a first state or a second state, and wherein: in the first state, the stacked LC structure converts incident light of a first polarization into light of a second polarization; and in the second state, the stacked LC structure transmits incident light without changing polarization of the incident light.

The common electrically conductive layer may act as an electrode for the first LC cell and the second LC cell. The bottom substrate may include a first electrically conductive layer adjacent to the first LC cell and the top substrate may include a second electrically conductive layer adjacent to the second LC cell, wherein the first electrically conductive layer and the common electrically conductive layer act as an electrode pair for the first LC cell and the second electrically conductive layer and the common electrically conductive layer act as an electrode pair for the second LC cell.

The stacked LC structure may be configurable to be in the first state or the second state by application of a voltage to the common electrically conductive layer.

In accordance with other examples, the disclosure is directed to a head mounted display comprising a display configured to emit image light; and an optical assembly configured to transmit the image light, wherein the optical assembly comprises: a stacked liquid crystal (LC) structure comprising a bottom substrate; a common substrate; a top substrate, a first LC cell disposed between the bottom substrate and the common substrate; a second LC cell disposed between the common substrate and the top substrate, wherein the common substrate includes or is coated with at least one electrically conductive layer that acts as an electrode for at least one of the two LC cells, wherein the stacked LC structure is configurable to be in a first state or a second state, wherein in the first state, the stacked LC structure converts incident light of a first polarization into light of a second polarization; and in the second state, the stacked LC structure transmits incident light without changing polarization of the incident light.

In any of the above examples, the stacked LC structure(s) may further include an optical element on an output surface of the top substrate, wherein behavior of the optical element depends on polarization of light incident on the optical element.

The details of one or more examples are set forth in the accompanying drawings and the description below. Other features and advantages will be apparent from the description and drawings, and from the claims.

### BRIEF DESCRIPTION OF THE DRAWINGS

FIG. 1 is an illustration depicting an example artificial reality system in which an optical assembly of a head mounted display (HMD) includes one or more stacked LC structures in accordance with the techniques described in this disclosure.

FIG. 2A is an illustration depicting an example HMD having an optical assembly that includes one or more stacked LC structures in accordance with techniques described in this disclosure.

FIG. 2B is an illustration depicting another example HMD, in accordance with techniques described in this disclosure.

FIG. 3 is a block diagram showing example implementations of a console, an HMD, and a peripheral device of the multi-device artificial reality systems of FIG. 1, in accordance with techniques described in this disclosure.

FIG. 4 is a block diagram depicting an example in which gesture detection, user interface generation, and virtual surface functions are performed by the HMD of the artificial reality systems of FIG. 1, in accordance with the techniques described in this disclosure.

FIG. 5 is a block diagram illustrating a more detailed example implementation of a distributed architecture for a multi-device artificial reality system in which one or more devices (e.g., peripheral device and HMD) are implemented using one or more System on a Chip (SoC) integrated circuits within each device, in accordance with the techniques described in this disclosure.

FIG. 6 illustrates an example stacked LC structure that includes two LC cells configured as Pi cells in accordance with some embodiments.

FIG. 7 illustrates an example stacked LC cell structure that includes two LC cells with antiparallel alignment in accordance with some embodiments.

FIG. 8A illustrates an example stacked LC cell structure that includes two LC cells with perpendicular alignment in accordance with some embodiments.

FIG. 8B illustrates an example stacked LC structure depicted in FIG. 8A in an alternate configuration in accordance with some embodiments.

FIG. 9 illustrates an example stacked LC structure having a common electrode layer in accordance with some embodiments.

FIG. 10 illustrates an example stacked LC structure of any of those shown in FIGS. 6-9 in combination with an optical element to form an optical stage in accordance with some embodiments.

### DETAILED DESCRIPTION

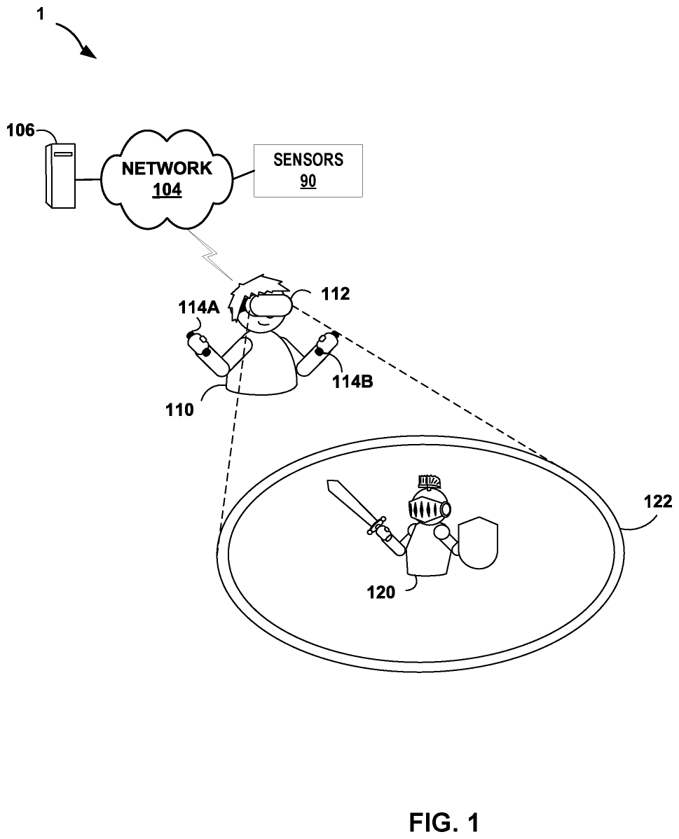

FIG. 1 is an illustration depicting an example artificial reality system 10 including a head mounted display (HMD) 112, one or more controllers 114A and 114B (collectively, “controller(s) 114”), and a console 106. HMD 112 is typically worn by a user 110 and includes an electronic display and optical assembly for presenting artificial reality content 122 to user 110. The optical assembly of HMD 112 includes one or more stacked LC structures in accordance with the techniques described in this disclosure. For example, the optical assembly of HMD 112 may include one or more stacked LC structures configured to transmit light in successive optical stages as part of a varifocal optical display assembly having adjustable optical power.

HMD 112 includes one or more sensors (e.g., accelerometers) for tracking motion of the HMD 112 and may include one or more image capture devices 138 (e.g., cameras, line scanners) for capturing image data of the surrounding physical environment. Although illustrated as a head-mounted display, AR system 10 may alternatively, or additionally, include glasses or other display devices for presenting artificial reality content 122 to user 110.

Each controller(s) 114 is an input device that user 110 may use to provide input to console 106, HMD 112, or another component of artificial reality system 10. Controller 114 may include one or more presence-sensitive surfaces for detecting user inputs by detecting a presence of one or more objects (e.g., fingers, stylus) touching or hovering over locations of the presence-sensitive surface. In some examples, controller(s) 114 may include an output display, which may be a presence-sensitive display. In some examples, controller(s) 114 may be a smartphone, tablet computer, personal data assistant (PDA), or other hand-held device. In some examples, controller(s) 114 may be a smartwatch, smartring, or other wearable device. Controller(s) 114 may also be part of a kiosk or other stationary or mobile system. Alternatively, or additionally, controller(s) 114 may include other user input mechanisms, such as one or more buttons, triggers, joysticks, D-pads, or the like, to enable a user to interact with and/or control aspects of the artificial reality content 122 presented to user 110 by artificial reality system 10.

In this example, console 106 is shown as a single computing device, such as a gaming console, workstation, a desktop computer, or a laptop. In other examples, console 106 may be distributed across a plurality of computing devices, such as distributed computing network, a data center, or cloud computing system. Console 106, HMD 112, and sensors 90 may, as shown in this example, be communicatively coupled via network 104, which may be a wired or wireless network, such as Wi-Fi, a mesh network or a short-range wireless communication medium, or combination thereof. Although HMD 112 is shown in this example as being in communication with, e.g., tethered to or in wireless communication with, console 106, in some implementations HMD 112 operates as a stand-alone, mobile artificial reality system, and artificial reality system 10 may omit console 106.

In general, artificial reality system 10 renders artificial reality content 122 for display to user 110 at HMD 112. In the example of FIG. 1, a user 110 views the artificial reality content 122 constructed and rendered by an artificial reality application executing on HMD 112 and/or console 106. In some examples, the artificial reality content 122 may be fully artificial, i.e., images not related to the environment in which user 110 is located. In some examples, artificial reality content 122 may comprise a mixture of real-world imagery (e.g., a hand of user 110, controller(s) 114, other environmental objects near user 110) and virtual objects to produce mixed reality and/or augmented reality. In some examples, virtual content items may be mapped (e.g., pinned, locked, placed) to a position within artificial reality content 122, e.g., relative to real-world imagery. A position for a virtual content item may be fixed, as relative to one of a wall or the earth, for instance. A position for a virtual content item may be variable, as relative to controller(s) 114 or a user, for instance. In some examples, the position of a virtual content item within artificial reality content 122 is associated with a position within the real-world, physical environment (e.g., on a surface of a physical object).

During operation, the artificial reality application constructs artificial reality content 122 for display to user 110 by tracking and computing pose information for a frame of reference, typically a viewing perspective of HMD 112. Using HMD 112 as a frame of reference, and based on a current field of view as determined by a current estimated pose of HMD 112, the artificial reality application renders 3D artificial reality content which, in some examples, may be overlaid, at least in part, upon the real-world, 3D physical environment of user 110. During this process, the artificial reality application uses sensed data received from HMD 112, such as movement information and user commands, and, in some examples, data from any external sensors 90, such as external cameras, to capture 3D information within the real world, physical environment, such as motion by user 110 and/or feature tracking information with respect to user 110. Based on the sensed data, the artificial reality application determines a current pose for the frame of reference of HMD 112 and, in accordance with the current pose, renders the artificial reality content 122.

Artificial reality system 10 may trigger generation and rendering of virtual content items based on a current field of view 130 of user 110, as may be determined by real-time gaze tracking of the user, or other conditions. More specifically, image capture devices 138 of HMD 112 capture image data representative of objects in the real-world, physical environment that are within a field of view 130 of image capture devices 138. Field of view 130 typically corresponds with the viewing perspective of HMD 112. In some examples, the artificial reality application presents artificial reality content 122 comprising mixed reality and/or augmented reality. As illustrated in FIG. 1A, the artificial reality application may render images of real-world objects, such as the portions of peripheral device 136, hand 132, and/or arm 134 of user 110, that are within field of view 130 along the virtual objects, such as within artificial reality content 122. In other examples, the artificial reality application may render virtual representations of the portions of peripheral device 136, hand 132, and/or arm 134 of user 110 that are within field of view 130 (e.g., render real-world objects as virtual objects) within artificial reality content 122. In either example, user 110 is able to view the portions of their hand 132, arm 134, peripheral device 136 and/or any other real-world objects that are within field of view 130 within artificial reality content 122. In other examples, the artificial reality application may not render representations of the hand 132 or arm 134 of the user.

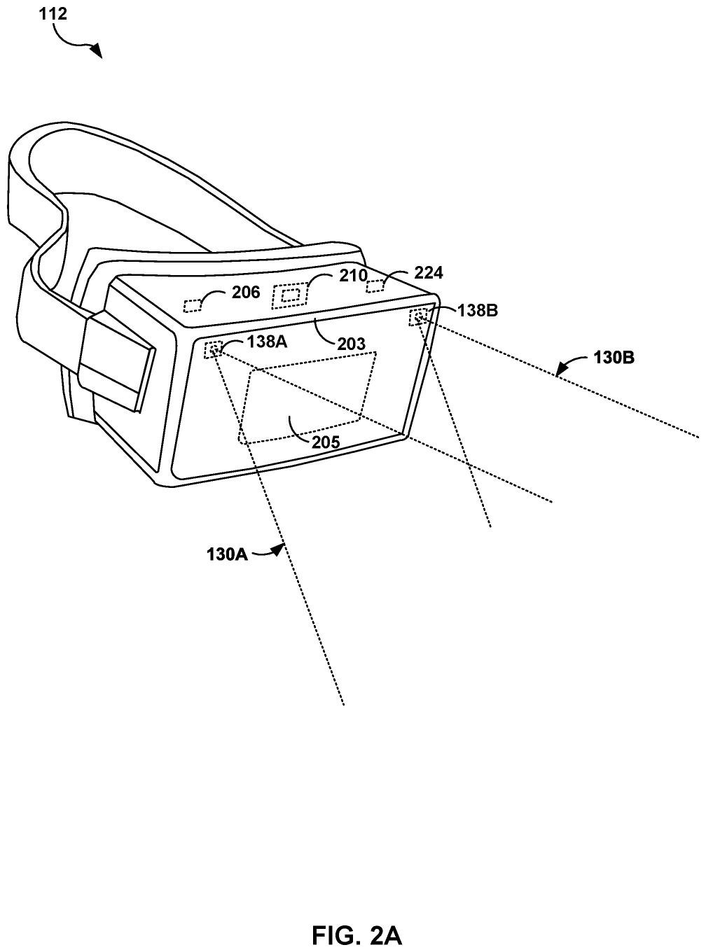

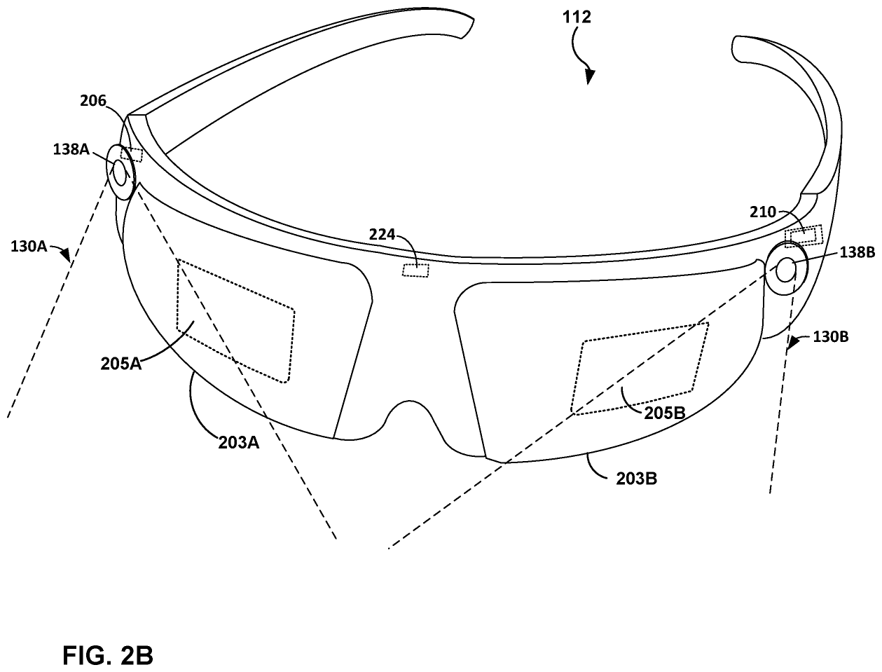

FIG. 2A is an illustration depicting an example HMD 112. HMD 112 may be part of an artificial reality system, such as artificial reality system 10 of FIG. 1, or may operate as a stand-alone, mobile artificial realty system configured to implement the techniques described herein. HMD 112 includes an optical assembly having one or more stacked LC structures in accordance with the techniques described in this disclosure.

In this example, HMD 112 includes a front rigid body and a band to secure HMD 112 to a user. In addition, HMD 112 includes an interior-facing electronic display 203 configured to present artificial reality content to the user via an optical assembly 205. Electronic display 203 may be any suitable display technology, such as liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating visual output. In some examples, the electronic display is a stereoscopic display for providing separate images to each eye of the user. In some examples, the known orientation and position of display 203 relative to the front rigid body of HMD 112 is used as a frame of reference, also referred to as a local origin, when tracking the position and orientation of HMD 112 for rendering artificial reality content according to a current viewing perspective of HMD 112 and the user. In other examples, HMD 112 may take the form of other wearable head mounted displays, such as glasses or goggles.

Optical assembly 205 includes optical elements configured to manage light output by electronic display 203 for viewing by the user of HMD 112 (e.g., user 110 of FIG. 1). The optical elements may include, for example, one or more lens, one or more diffractive optical element, one or more reflective optical elements, one or more waveguide, or the like, that manipulates (e.g., focuses, defocuses, reflects, refracts, diffracts, or the like) light output by electronic display. In accordance with the techniques of the present disclosure, optical assembly 205 includes one or more stacked LC structures. For example, optical assembly 205 may include one or more stacked LC structures configured to transmit light in successive optical stages as part of a varifocal optical display assembly having adjustable optical power. The stacked LC structure may include two LC cells arranged in optical series that share a common substrate between the LC cells. In some previous stacked LC structures, each LC cell is surrounded by corresponding first and second substrates (e.g., one substrate on a first side of the LC cell and one substrate on a second side of the LC cell). By sharing a common, middle substrate, the total thickness of the stacked LC structure may be reduced. This may reduce a size or thickness of optical assembly 205. Reducing the size or thickness of optical assembly 205 may enable a reduction in size and weight of HMD 112, which may improve comfort of user 110.

As further shown in FIG. 2A, in this example, HMD 112 further includes one or more motion sensors 206, such as one or more accelerometers (also referred to as inertial measurement units or “IMUs”) that output data indicative of current acceleration of HMD 112, GPS sensors that output data indicative of a location of HMD 112, radar or sonar that output data indicative of distances of HMD 112 from various objects, or other sensors that provide indications of a location or orientation of HMD 112 or other objects within a physical environment. Moreover, HMD 112 may include integrated image capture devices 138A and 138B (collectively, “image capture devices 138”), such as video cameras, laser scanners, Doppler radar scanners, depth scanners, or the like, configured to output image data representative of the physical environment. More specifically, image capture devices 138 capture image data representative of objects (including peripheral device 136 and/or hand 132) in the physical environment that are within a field of view 130A, 130B of image capture devices 138, which typically corresponds with the viewing perspective of HMD 112. HMD 112 includes an internal control unit 210, which may include an internal power source and one or more printed-circuit boards having one or more processors, memory, and hardware to provide an operating environment for executing programmable operations to process sensed data and present artificial reality content on display 203.

FIG. 2B is an illustration depicting another example HMD 112, in accordance with techniques described in this disclosure. As shown in FIG. 2B, HMD 112 may take the form of glasses. HMD 112 of FIG. 2A may be an example of any of HMDs 112 of FIGS. 1A and 1B. HMD 112 may be part of an artificial reality system, such as artificial reality systems 10, 20 of FIGS. 1A, 1B, or may operate as a stand-alone, mobile artificial realty system configured to implement the techniques described herein.

In this example, HMD 112 are glasses comprising a front frame including a bridge to allow the HMD 112 to rest on a user's nose and temples (or “arms”) that extend over the user's ears to secure HMD 112 to the user. In addition, HMD 112 of FIG. 2B includes one or more interior-facing electronic displays 203A and 203B (collectively, “electronic displays 203”) configured to present artificial reality content to the user and one or more optical assemblies 205A and 205B (collectively, “optical assemblies 205”) configured to manage light output by interior-facing electronic displays 203A and 203B. Electronic displays 203 may be any suitable display technology, such as liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating visual output. In the example shown in FIG. 2B, electronic displays 203 form a stereoscopic display for providing separate images to each eye of the user. In some examples, the known orientation and position of display 203 relative to the front frame of HMD 112 is used as a frame of reference, also referred to as a local origin, when tracking the position and orientation of HMD 112 for rendering artificial reality content according to a current viewing perspective of HMD 112 and the user.

Optical assemblies 205 include optical elements configured to manage light output by electronic displays 203 for viewing by the user of HMD 112 (e.g., user 110 of FIG. 1). The optical elements may include, for example, one or more lens, one or more diffractive optical element, one or more reflective optical elements, one or more waveguide, or the like, that manipulates (e.g., focuses, defocuses, reflects, refracts, diffracts, or the like) light output by electronic display. In accordance with the techniques of the present disclosure, each of optical assemblies 205 include one or more stacked LC structures. For example, each optical assembly 205 may include one or more stacked LC structures configured to transmit light in successive optical stages as part of a varifocal optical display assembly having adjustable optical power.

As further shown in FIG. 2B, in this example, HMD 112 further includes one or more motion sensors 206, such as one or more accelerometers (also referred to as inertial measurement units or “IMUs”) that output data indicative of current acceleration of HMD 112, GPS sensors that output data indicative of a location of HMD 112, radar or sonar that output data indicative of distances of HMD 112 from various objects, or other sensors that provide indications of a location or orientation of HMD 112 or other objects within a physical environment. Moreover, HMD 112 may include integrated image capture devices 138A and 138B (collectively, “image capture devices 138”), such as video cameras, laser scanners, Doppler radar scanners, depth scanners, or the like, configured to output image data representative of the physical environment. HMD 112 includes an internal control unit 210, which may include an internal power source and one or more printed-circuit boards having one or more processors, memory, and hardware to provide an operating environment for executing programmable operations to process sensed data and present artificial reality content on display 203.

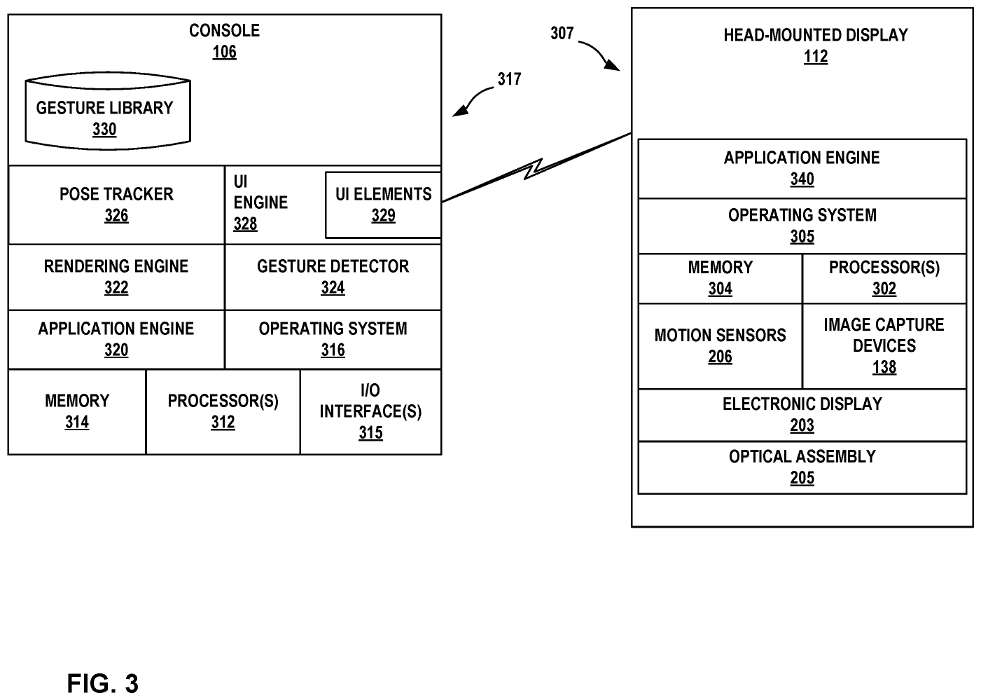

FIG. 3 is a block diagram showing an example implementation of an artificial reality system that includes console 106 and HMD 112, in accordance with techniques described in this disclosure. In the example of FIG. 3, console 106 performs pose tracking, gesture detection, and user interface generation and rendering for HMD 112 based on sensed data, such as motion data and image data received from HMD 112 and/or external sensors.

In this example, HMD 112 includes one or more processors 302 and memory 304 that, in some examples, provide a computer platform for executing an operating system 305, which may be an embedded, real-time multitasking operating system, for instance, or other type of operating system. In turn, operating system 305 provides a multitasking operating environment for executing one or more software components 307, including application engine 340. As discussed with respect to the examples of FIGS. 2A and 2B, processors 302 are coupled to electronic display 203, motion sensors 206, image capture devices 138, and optical assemblies 205. In some examples, processors 302 and memory 304 may be separate, discrete components. In other examples, memory 304 may be on-chip memory collocated with processors 302 within a single integrated circuit.

In general, console 106 is a computing device that processes image and tracking information received from cameras 102 (FIG. 1) and/or image capture devices 138 HMD 112 (FIGS. 2A and 2B) to perform gesture detection and user interface and/or virtual content generation for HMD 112. In some examples, console 106 is a single computing device, such as a workstation, a desktop computer, a laptop, or gaming system. In some examples, at least a portion of console 106, such as processors 312 and/or memory 314, may be distributed across a cloud computing system, a data center, or across a network, such as the Internet, another public or private communications network, for instance, broadband, cellular, Wi-Fi, and/or other types of communication networks for transmitting data between computing systems, servers, and computing devices.

In the example of FIG. 3, console 106 includes one or more processors 312 and memory 314 that, in some examples, provide a computer platform for executing an operating system 316, which may be an embedded, real-time multitasking operating system, for instance, or other type of operating system. In turn, operating system 316 provides a multitasking operating environment for executing one or more software components 317. Processors 312 are coupled to one or more I/O interfaces 315, which provides one or more I/O interfaces for communicating with external devices, such as a keyboard, game controller(s), display device(s), image capture device(s), HMD(s), peripheral device(s), and the like. Moreover, the one or more I/O interfaces 315 may include one or more wired or wireless network interface controllers (NICs) for communicating with a network, such as network 104.

Software applications 317 of console 106 operate to provide an overall artificial reality application. In this example, software applications 317 include application engine 320, rendering engine 322, gesture detector 324, pose tracker 326, and user interface engine 328.

In general, application engine 320 includes functionality to provide and present an artificial reality application, e.g., a teleconference application, a gaming application, a navigation application, an educational application, training or simulation applications, and the like. Application engine 320 may include, for example, one or more software packages, software libraries, hardware drivers, and/or Application Program Interfaces (APIs) for implementing an artificial reality application on console 106. Responsive to control by application engine 320, rendering engine 322 generates 3D artificial reality content for display to the user by application engine 340 of HMD 112.

Application engine 320 and rendering engine 322 construct the artificial content for display to user 110 in accordance with current pose information for a frame of reference, typically a viewing perspective of HMD 112, as determined by pose tracker 326. Based on the current viewing perspective, rendering engine 322 constructs the 3D, artificial reality content which may in some cases be overlaid, at least in part, upon the real-world 3D environment of user 110. During this process, pose tracker 326 operates on sensed data received from HMD 112, such as movement information and user commands, and, in some examples, data from any external sensors 90 (FIGS. 1A, 1B), such as external cameras, to capture 3D information within the real-world environment, such as motion by user 110 and/or feature tracking information with respect to user 110. Based on the sensed data, pose tracker 326 determines a current pose for the frame of reference of HMD 112 and, in accordance with the current pose, constructs the artificial reality content for communication, via the one or more I/O interfaces 315, to HMD 112 for display to user 110.

Pose tracker 326 may determine a current pose for HMD 112 and, in accordance with the current pose, triggers certain functionality associated with any rendered virtual content (e.g., places a virtual content item onto a virtual surface, manipulates a virtual content item, generates and renders one or more virtual markings, generates and renders a laser pointer). In some examples, pose tracker 326 detects whether the HMD 112 is proximate to a physical position corresponding to a virtual surface (e.g., a virtual pinboard), to trigger rendering of virtual content.

User interface engine 328 is configured to generate virtual user interfaces for rendering in an artificial reality environment. User interface engine 328 generates a virtual user interface to include one or more virtual user interface elements 329, such as a virtual drawing interface, a selectable menu (e.g., drop-down menu), virtual buttons, a directional pad, a keyboard, or other user-selectable user interface elements, glyphs, display elements, content, user interface controls, and so forth.

Console 106 may output this virtual user interface and other artificial reality content, via a communication channel, to HMD 112 for display at HMD 112.

Based on the sensed data from any of the image capture devices 138 or 102, or other sensor devices, gesture detector 324 analyzes the tracked motions, configurations, positions, and/or orientations of controllers 114 and/or objects (e.g., hands, arms, wrists, fingers, palms, thumbs) of the user 110 to identify one or more gestures performed by user 110. More specifically, gesture detector 324 analyzes objects recognized within image data captured by image capture devices 138 of HMD 112 and/or sensors 90 and external cameras 102 to identify controller(s) 114 and/or a hand and/or arm of user 110, and track movements of controller(s) 114, hand, and/or arm relative to HMD 112 to identify gestures performed by user 110. In some examples, gesture detector 324 may track movement, including changes to position and orientation, of controller(s) 114, hand, digits, and/or arm based on the captured image data, and compare motion vectors of the objects to one or more entries in gesture library 330 to detect a gesture or combination of gestures performed by user 110. In some examples, gesture detector 324 may receive user inputs detected by presence-sensitive surface(s) of controller(s) 114 and process the user inputs to detect one or more gestures performed by user 110 with respect to controller(s) 114.

In accordance with the techniques described herein, optical assemblies 205A and 205B each include one or more stacked LC structures. For example, optical assembly 205 may include one or more stacked LC structures configured to transmit light in successive optical stages to provide a varifocal optical display assembly having adjustable optical power. The stacked LC structure may include two LC cells arranged in optical series that share a common substrate between the LC cells. In some previous stacked LC structures, each LC cell is surrounded by corresponding first and second substrates (e.g., one substrate on a first side of the LC cell and one substrate on a second side of the LC cell). By sharing a common, middle substrate, the total thickness of the stacked LC structure may be reduced. This may reduce a size or thickness of optical assemblies 205A and 205B. Reducing the size or thickness of optical assemblies 205A and 205B may enable a reduction in size and weight of HMD 112, which may improve comfort of user 110.

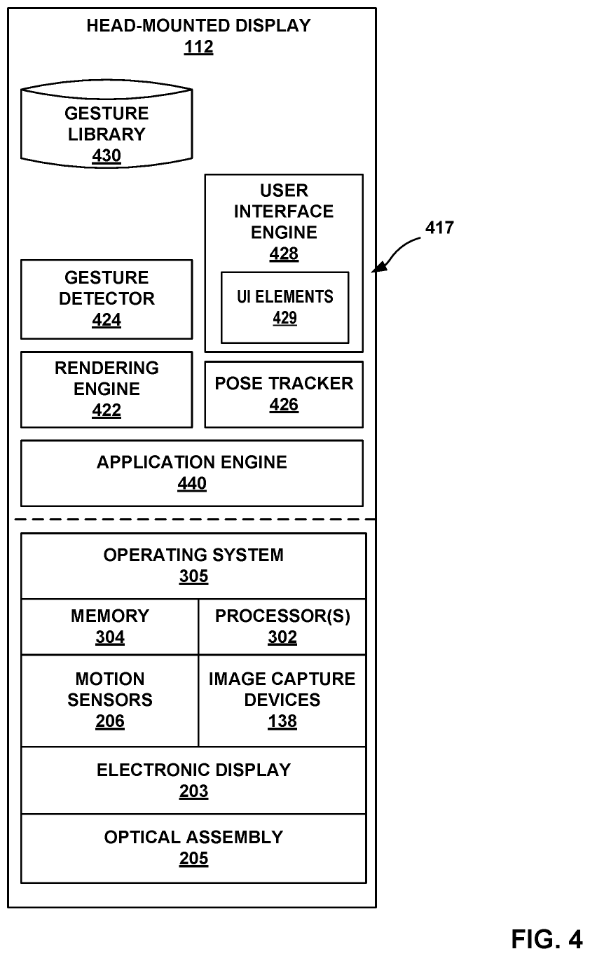

FIG. 4 is a block diagram depicting an example in which HMD 112 is a standalone artificial reality system, in accordance with the techniques described in this disclosure.

In this example, like FIG. 3, HMD 112 includes one or more processors 302 and memory 304 that, in some examples, provide a computer platform for executing an operating system 305, which may be an embedded, real-time multitasking operating system, for instance, or other type of operating system. In turn, operating system 305 provides a multitasking operating environment for executing one or more software components 417. Moreover, processor(s) 302 are coupled to electronic display 203, motion sensors 206, and image capture devices 138.

In the example of FIG. 4, software components 417 operate to provide an overall artificial reality application. In this example, software applications 417 include application engine 440, rendering engine 422, gesture detector 424, pose tracker 426, and user interface engine 428. In various examples, software components 417 operate similar to the counterpart components of console 106 of FIG. 3 (e.g., application engine 320, rendering engine 322, gesture detector 324, pose tracker 326, and user interface engine 328) to construct virtual user interfaces overlaid on, or as part of, the artificial content for display to user 110.

Similar to the examples described with respect to FIG. 3, based on the sensed data from any of the image capture devices 138 or 102, controller(s) 114, or other sensor devices, gesture detector 424 analyzes the tracked motions, configurations, positions, and/or orientations of controller(s) 114 and/or objects (e.g., hands, arms, wrists, fingers, palms, thumbs) of the user to identify one or more gestures performed by user 110.

In accordance with the techniques described herein, optical assembly 205 includes one or more stacked LC structures. For example, optical assembly 205 may include one or more stacked LC structures configured to transmit light in successive optical stages as part of a varifocal optical display assembly having adjustable optical power.

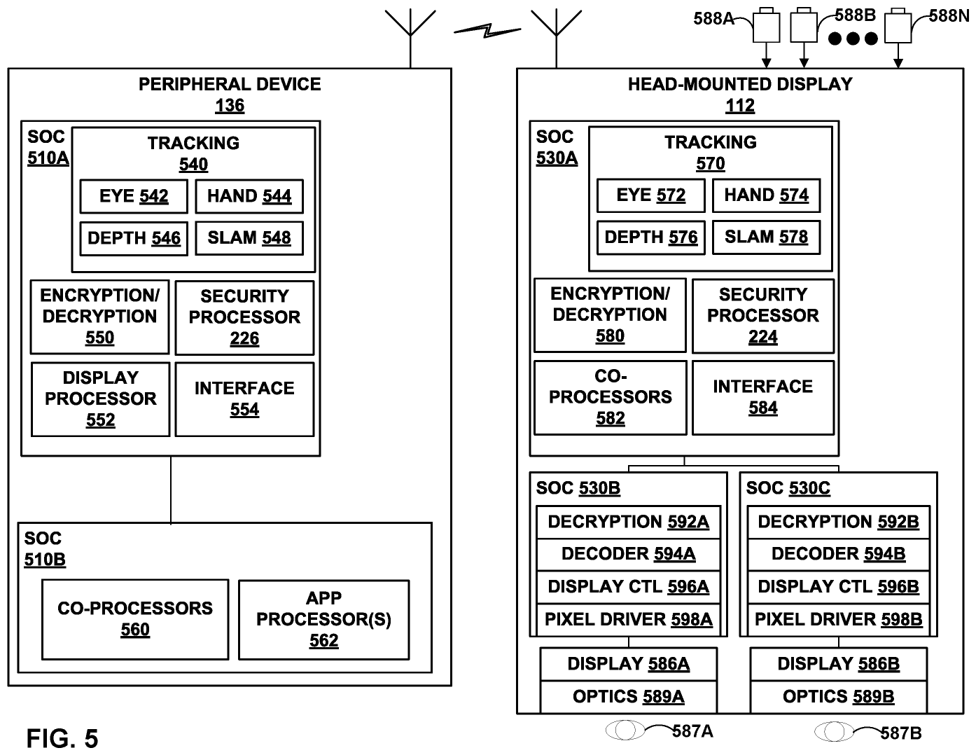

FIG. 5 is a block diagram illustrating a more detailed example implementation of a distributed architecture for an artificial reality system in which one or more devices (e.g., a peripheral device 136 and HMD 112) are implemented using one or more System on a Chip (SoC) integrated circuits within each device. Peripheral device 136 and HMD 112 are architected and configured to enable secure, privacy-preserving device attestation and mutual authentication.

Peripheral device 136 is a physical, real-world device having a surface on which AR system 10 overlays virtual user interface 137. Peripheral device 136 may include one or more presence-sensitive surfaces for detecting user inputs by detecting a presence of one or more objects (e.g., fingers, stylus) touching or hovering over locations of the presence-sensitive surface. In some examples, peripheral device 136 may include an output display, which may be a presence-sensitive display. In some examples, peripheral device 136 may be a smartphone, tablet computer, personal data assistant (PDA), or other hand-held device. In some examples, peripheral device 136 may be a smartwatch, smartring, or other wearable device. Peripheral device 136 may also be part of a kiosk or other stationary or mobile system. Peripheral device 136 may or may not include a display device for outputting content to a screen.

In general, the SoCs illustrated in FIG. 5 represent a collection of specialized integrated circuits arranged in a distributed architecture, where each SoC integrated circuit includes various specialized functional blocks configured to provide an operating environment for artificial reality applications. FIG. 5 is merely one example arrangement of SoC integrated circuits. The distributed architecture for a multi-device artificial reality system may include any collection and/or arrangement of SoC integrated circuits.

In this example, SoC 530A of HMD 112 includes functional blocks including security processor 224, tracking 570, encryption/decryption 580, co-processors 582, and interface 584. Tracking 570 provides a functional block for eye tracking 572 (“eye 572”), hand tracking 574 (“hand 574”), depth tracking 576 (“depth 576”), and/or Simultaneous Localization and Mapping (SLAM) 578 (“SLAM 578”). For example, HMD 112 may receive input from one or more accelerometers (also referred to as inertial measurement units or “IMUs”) that output data indicative of current acceleration of HMD 112, GPS sensors that output data indicative of a location of HMD 112, radar or sonar that output data indicative of distances of HMD 112 from various objects, or other sensors that provide indications of a location or orientation of HMD 112 or other objects within a physical environment. HMD 112 may also receive image data from one or more image capture devices 588A-588N (collectively, “image capture devices 588”). Image capture devices may include video cameras, laser scanners, Doppler radar scanners, depth scanners, or the like, configured to output image data representative of the physical environment. More specifically, image capture devices capture image data representative of objects (including peripheral device 136 and/or a hand) in the physical environment that are within a field of view of image capture devices, which typically corresponds with the viewing perspective of HMD 112. Based on the sensed data and/or image data, tracking 570 determines, for example, a current pose for the frame of reference of HMD 112 and, in accordance with the current pose, renders the artificial reality content.

Encryption/decryption 580 is a functional block to encrypt outgoing data communicated to peripheral device 136 or a security server and decrypt incoming data communicated from peripheral device 136 or a security server. Encryption/decryption 580 may support symmetric key cryptography to encrypt/decrypt data with a session key (e.g., secret symmetric key).

Co-application processors 582 includes various processors such as a video processing unit, graphics processing unit, digital signal processors, encoders and/or decoders, and/or others.

Interface 584 is a functional block that includes one or more interfaces for connecting to functional blocks of SoC 530A. As one example, interface 584 may include peripheral component interconnect express (PCIe) slots. SoC 530A may connect with SoC 530B, 530C using interface 584. SoC 530A may connect with a communication device (e.g., radio transmitter) using interface 584 for communicating with other devices, e.g., peripheral device 136.

Security processor 224 provides secure device attestation and mutual authentication of HMD 112 when pairing with devices, e.g., peripheral device 136, used in conjunction within the AR environment. When HMD 112 is powered on and performs a secure boot, security processor 224 may authenticate SoCs 530A-530C of HMD 112 based on the pairing certificate stored in NVM 534. If a pairing certificate does not exist or the devices to be paired have changed, security processor 224 may send to the security server the device certificates of SoCs 530A-530C for attestation.

SoCs 530B and 530C each represent display controllers for outputting artificial reality content on respective displays, e.g., displays 586A, 586B (collectively, “displays 586”). In this example, SoC 530B may include a display controller for display 568A to output artificial reality content for a left eye 587A of a user via an optical assembly 589A. For example, SoC 530B includes a decryption block 592A, decoder block 594A, display controller 596A, and/or a pixel driver 598A for outputting artificial reality content on display 586A. Similarly, SoC 530C may include a display controller for display 568B to output artificial reality content for a right eye 587B of the user. For example, SoC 530C includes decryption 592B, decoder 594B, display controller 596B, and/or a pixel driver 598B for generating and outputting artificial reality content on display 586B. Displays 568 may include Light-Emitting Diode (LED) displays, Organic LEDs (OLEDs), Quantum dot LEDs (QLEDs), Electronic paper (E-ink) displays, Liquid Crystal Displays (LCDs), or other types of displays for displaying AR content.

Optics assemblies 589A and 589B include optical elements configured to transmit and manage light output by electronic displays 586A and 586B, respectively, for viewing by the user of HMD 112 (e.g., user 110 of FIG. 1). The optical elements may include, for example, one or more lens, one or more diffractive optical element, one or more reflective optical elements, one or more waveguide, or the like, that manipulates (e.g., focuses, defocuses, reflects, refracts, diffracts, scatters, or the like) light output by electronic displays 586A and 586B. In accordance with the techniques of the present disclosure, each of optical assemblies 589A and 589B includes one or more stacked LC structures. For example, each of optical assemblies 589A and 589B may include one or more stacked LC structures configured to transmit light in successive optical stages as part of a varifocal optical display assembly having adjustable optical power. The stacked LC structure may include two LC cells arranged in optical series that share a common substrate between the LC cells. In some previous stacked LC structures, each LC cell is surrounded by corresponding first and second substrates (e.g., one substrate on a first side of the LC cell and one substrate on a second side of the LC cell). By sharing a common, middle substrate, the total thickness of the stacked LC structure may be reduced. This may reduce a size or thickness of optical assemblies 589A and 589B. Reducing the size or thickness of optical assemblies 589A and 589B may enable a reduction in size and weight of HMD 112, which may improve comfort of user 110.

In some examples, the stacked LC structure may be a switchable waveplate or retarder, in which the stacked LC structure may be configured in a first optical state (e.g., an “off” state) or a second optical state (e.g., an “on” state). In the first optical state, the stacked LC structure may be configured to convert incident light to transmitted light having a different polarization from that of the incident light. The different polarization may be any suitable changed polarization, including conversion of linearly polarized light to circularly polarized light or vice-versa (a nominal quarter-wave plate), conversion of light of one linear polarization into an orthogonal linear polarization or light of one circular polarization into an orthogonal circular polarization (a nominal half-wave plate), or the like. In the second optical state, the stacked LC structure may be configured to transmit incident light without changing its polarization. In this way, the stacked LC structure may be used to manage polarization of the image light as it is transmitted through optics assemblies 589A and 589B, which may include polarization sensitive or polarization dependent optical elements.

Peripheral device 136 includes SoCs 510A and 510B configured to support an artificial reality application. In this example, SoC 510A comprises functional blocks including security processor 226, tracking 540, an encryption/decryption 550, a display processor 552, and an interface 554. Tracking 540 is a functional block providing eye tracking 542 (“eye 542”), hand tracking 544 (“hand 544”), depth tracking 546 (“depth 546”), and/or Simultaneous Localization and Mapping (SLAM) 548 (“SLAM 548”). For example, peripheral device 136 may receive input from one or more accelerometers (also referred to as inertial measurement units or “IMUs”) that output data indicative of current acceleration of peripheral device 136, GPS sensors that output data indicative of a location of peripheral device 136, radar or sonar that output data indicative of distances of peripheral device 136 from various objects, or other sensors that provide indications of a location or orientation of peripheral device 136 or other objects within a physical environment. Peripheral device 136 may in some examples also receive image data from one or more image capture devices, such as video cameras, laser scanners, Doppler radar scanners, depth scanners, or the like, configured to output image data representative of the physical environment. Based on the sensed data and/or image data, tracking block 540 determines, for example, a current pose for the frame of reference of peripheral device 136 and, in accordance with the current pose, renders the artificial reality content to HMD 112.

Encryption/decryption 550 encrypts outgoing data communicated to HMD 112 or a security server and decrypts incoming data communicated from HMD 112 or a security server.

Display processor 552 includes one or more processors such as a video processing unit, graphics processing unit, encoders and/or decoders, and/or others, for rendering artificial reality content to HMD 112.

Interface 554 includes one or more interfaces for connecting to functional blocks of SoC 510A. As one example, interface 584 may include peripheral component interconnect express (PCIe) slots. SoC 510A may connect with SoC 510B using interface 584. SoC 510A may connect with one or more communication devices (e.g., radio transmitter) using interface 584 for communicating with other devices, e.g., HMD 112.

Security processor 226 provides secure device attestation and mutual authentication of peripheral device 136 when pairing with devices, e.g., HMD 112, used in conjunction within the AR environment. When peripheral device 136 is powered on and performs a secure boot, security processor 226 may authenticate SoCs 510A, 510B of peripheral device 136 based on the pairing certificate stored in NVM 514. If a pairing certificate does not exist or the devices to be paired have changed, security processor 226 may send to security server 140 device certificates of SoCs 510A, 510B for attestation.

SoC 510B includes co-application processors 560 and application processors 562. In this example, co-application processors 560 includes various processors, such as a vision processing unit (VPU), a graphics processing unit (GPU), and/or central processing unit (CPU). Application processors 562 may include a processing unit for executing one or more artificial reality applications to generate and render, for example, a virtual user interface to a surface of peripheral device 136 and/or to detect gestures performed by a user with respect to peripheral device 136.

In accordance with the present disclosure, each of optical assemblies 205 (as shown in FIGS. 2A, 2B, 3 and 4) and optical assemblies 589A and 589B (as shown in FIG. 5) include one or more stacked LC structures configured to apply a phase adjustment to a polarization of a broadband light incident on an input side of the stacked LC structure. The amount of phase adjustment is such that a polarization of the broadband light is rotated. In some embodiments, a stacked LC structure includes two or more liquid crystal (LC) cells arranged in optical series. The stacked LC structure may further include one or more substrate layers, including a common substrate between adjacent LC cells, and/or one or more electrode layers.

As broadband light passes through each LC cell in the stack, each LC cell applies an amount of phase adjustment to a polarization of the broadband light. As used herein, phase adjustment refers to a change in a phase between polarization vector components of light and/or a rotation of polarization vector components. Note that the phase may be zero, and the change in phase may be to make it non-zero or vice versa. In some examples, the amount of phase adjustment may cause a rotation of linearly polarized light (e.g., rotation by 90 degrees), or a change in handedness for circularly polarized light (e.g., right circularly polarized to left circularly polarized, or vice versa). Accordingly, in some examples, the stacked LC structure may function as a half-wave plate. In other examples, the stacked LC structure may act as a quarter-wave plate, converting linearly polarized light to circularly polarized light and vice versa. In some examples, the total amount of phase adjustment acts to rotate the polarization of the broadband light (e.g., rotate linearly polarized light by some amount). In other examples, the stacked LC structure may act as a waveplate or retarder imparting a selected polarization change to incident light. Broadband light may include, for example, the entire visible spectrum.

In some embodiments, for example, a stacked LC structure may be configurable via a respective controller (e.g., via application of a control voltage) to be in a first optical state (e.g., an “off” state) or a second optical state (e.g., an “on” state). In the first optical state, the stacked LC structure may be configured to convert incident light to transmitted light having a different polarization from that of the incident light. In the second optical state, the stacked LC structure may be configured to transmit incident light without changing its polarization. For example, when the stacked LC structure is set to the first state and is configured to be a half-wave plate, left circularly polarized (LCP) light incident upon the stacked LC structure will be transmitted as right circularly polarized (RCP) light, and vice versa. In contrast, when the stacked LC structure is set to the second state and is configured to be a zero-wave plate or a full-wave plate, light incident upon the stacked LC structure will be transmitted without a change in its polarization (e.g., LCP light remains LCP and RCP light remains RCP). In this manner, the stacked LC structure may be considered to be “switchable” in that the optical transmission characteristics of the stacked LC structure may be changed or controlled based on an applied voltage.

In some embodiments, each stacked LC structure includes two LC cells arranged in optical series such that light incident on and transmitted through a first LC cell is incident on and transmitted through a second LC cell. The two LC cells are configured to have an anti-parallel or a perpendicular alignment to one another. The LC cells within a stacked LC structure may be in an active or a passive state and are configured to contribute some amount of phase adjustment to light emitted by the stacked LC structure. The stacked LC structure may be wavelength independent for a range of wavelengths inclusive of the broadband light over a broad range of incident angle.

A stacked LC structure may include one or more electrode layers such that the state of the stacked LC structure may be controlled based on a voltage applied using the one or more electrode layers. For example, a control voltage may be applied to one or more electrode layers of a stacked LC structure to control the amount of phase adjustment to a polarization of broadband light incident on an input side of the stacked LC structure. In this way, an optical assembly of HMD 112 may include one or more stacked LC structures configured to be part of a varifocal optical display assembly having adjustable optical power.

Example varifocal optical display assemblies are described in U.S. application Ser. No. 15/693,839, filed Sep. 1, 2017, and U.S. application Ser. No. 16/355,612, “Display Device with Varifocal Optical Assembly,” filed Mar. 15, 2019, both of which are incorporated herein by reference in their entirety. The varifocal optical display assembly may also be used in other HMDs and/or other applications where a phase adjustment is applied to a polarization of light or a polarization of light is rotated over a broad range of wavelengths range and over a broad range of incident angles.

In some examples, an optical assembly of an HMD may include one or more optical elements in addition to the one or more stacked LC structures. The one or more optical elements may be arranged in series with the one or more stacked LC structures, and may be arranged either before (on the input side) the one or more stacked LC structures, after (on the output side) of the one or more stacked LC structures, or between any of the one or more stacked LC structures. For example, the optical element(s) may act to perform some optical adjustment on the light incident on, or exiting from, one of the one or more stacked LC structures. As another example, the optical element(s) may act to correct aberrations in image light emitted from a stacked LC structure, act as a lens (apply a positive or negative optical power) to image light emitted from a stacked LC structure, perform some other optical adjustment of image light emitted from a stacked LC structure, or some combination thereof. The optical elements may include, for example, an aperture, a Fresnel lens, a convex lens, a concave lens, a diffractive element, a waveguide, a filter, a polarizer, a diffuser, a fiber taper, one or more reflective surfaces, a polarizing reflective surface, a birefringent element, a Pancharatnam-Berry phase (PBP) lens (also called a geometric phase lens), a PBP grating (also called a geometric phase grating), a polarization sensitive hologram (PSH) lens, a PSH grating, a liquid crystal optical phase array, or any other suitable optical element that affects image light incident on or emitted from a stacked LC structure.

For example, a varifocal optical display may include a plurality of PBP lenses, which exhibit a positive or negative focal length depending on polarization of incident light. The varifocal optical display may include a corresponding stacked LC structure before each PBP lens. The stacked LC structure may be configured and controlled to select the circular polarization of the light incident to the following PBP lens, thus controlling whether the PBP lens exhibits positive or negative focal power.

One or more of the LC cells in a stacked LC structure may include, for example, a film type LC cell or a thin-glass type LC cell. Each LC cell in a stacked LC structure may operate in one of a plurality of optical modes including an electronically controlled birefringence (ECB) mode, a vertical alignment (VA) mode, a multi-domain vertical alignment (MVA) mode, a twisted nematic (TN) mode, a super twisted nematic (STN) mode, an optically compensated bend (OCB) mode, or any other liquid crystal mode.

The LC cells in the stacked LC structure may be active, passive, or some combination thereof. In some embodiments, at least one of the LC cells is a nematic LC cell, a nematic LC cell with chiral dopants, a chiral LC cell, a uniform lying helix (ULH) LC cell, or a ferroelectric LC cell. In some embodiments, the LC cell includes electrically drivable birefringent materials.

In some examples, each LC cell within a stacked LC structure may be aligned to be perpendicular to an adjacent LC cell in the stacked LC structure. In a perpendicular alignment, the average molecular alignment of adjacent LC cells are configured to be orthogonal to one another. In some examples, each LC cell within a stacked LC structure may have an anti-parallel alignment to an adjacent LC cell in the stacked LC structure. In an anti-parallel alignment, both a first LC cell and an adjacent, second LC cell run parallel to one another but with opposite optical alignments. That is, in an anti-parallel alignment, the average molecular alignment of the first LC cell is configured to be anti-parallel to that of the second LC cell. In some examples, adjacent LC cells are neither perpendicular nor parallel, and may be designed to have an average molecular alignment between 0-90 degrees depending upon the desired optical behavior of stacked LC structure 600.

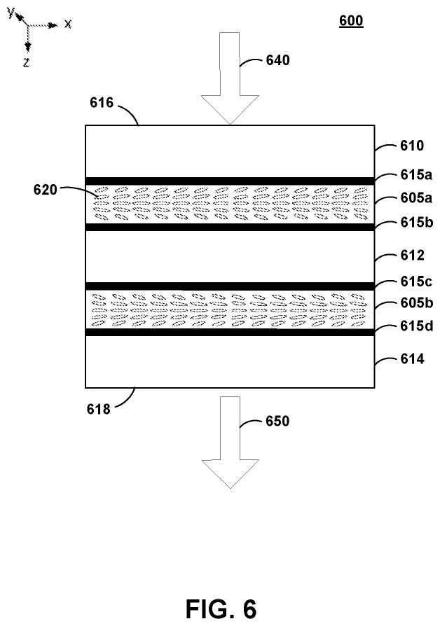

FIG. 6 illustrates an example stacked LC structure 600. In general, the stacked LC structures described herein have an input side or surface 616 (the side or surface that receives incident light 640) and an output side or surface 618 (the side or surface through which the light 650 is transmitted). Likewise, each layer within a stacked LC structure has corresponding input (light incident) and output (light transmitted) sides. In this example, stacked LC structure 600 includes two LC cells 605a and 605b, a first, bottom substrate 610, a second, common substrate 612, and third, top substrate 614. By sharing second, common substrate 612, a thickness of stacked LC structure 600 may be reduced compared to a stacked LC structure in which each LC cell 605a, 605b is associated with corresponding top and bottom substrates. In other examples, a stacked LC structure may include at least two liquid crystal (LC) cells arranged in optical series that share a common substrate between adjacent LC cells. Therefore, although stacked LC structures including two LC cells are shown and described with respect to FIGS. 6-10 for purposes of illustration, it shall be understood that the disclosure is not limited in this respect, and that stacked LC structure(s) may generally include a plurality of LC cells.

Stacked LC structure 600 includes a common substrate 612 having a first electrode 615b on an input side of the common substrate 612 and a second electrode 615c on an output side of the common substrate 612 and omits a substrate layer that would otherwise be present between the first and second LC cells 605a and 605b, allowing reduced thickness of the overall stacked LC structure 600. This may reduce a size and weight of an optical assembly in which stacked LC structure 600 is used, which is an important consideration for user comfort of a head-mounted display. The reduced thickness achieved by eliminating a substrate layer in a stacked LC structure may be even more apparent when multiple stacked LC structures are used in successive optical stages to provide a varifocal optical display assembly having adjustable optical power.

In this example, each of LC cells 605a and LC cell 605b is configured as a Pi cell and is comprised of optically isotropic colloidal systems in which the dispersive medium is a highly structured liquid that is sensitive to electric and magnetic fields. LC cells 605a and 605b each suspend a plurality of LC molecules 620. In various examples, each of LC cell 605a and LC cell 605b is less than 50 micrometers (μm) thick (along the optical propagation direction). For example, each of LC cell 605a and LC cell 605b may be less than 10 μm thick (along the optical propagation direction). It shall be understood that the thickness of each LC cell is may vary based on, for example, an index of refraction of the liquid crystal material, or a birefringence of the liquid crystal material (a difference in indices of refraction for different polarizations).

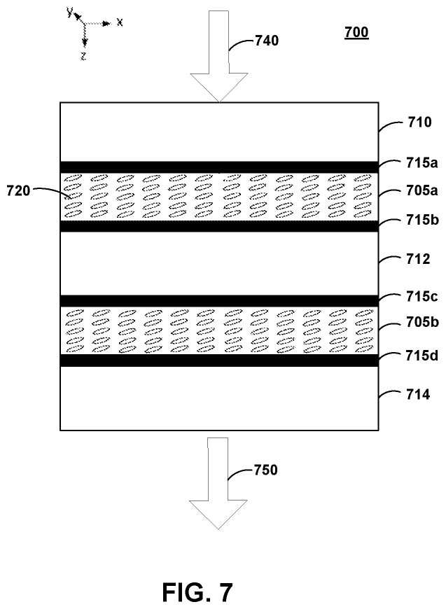

In the example of FIG. 6, LC cells 605a and 605b are both stabilized into a Pi state. That is, the plurality of LC molecules 620 encapsulated within the LC cells 605a and 605b are configured to form Pi cells. Pi cells are generally used in applications requiring fast response times and increased viewing angle (e.g., large screen televisions and high-speed optical shutters). In LC cells 605a and 605b, the plurality of LC molecules 620 has a 180° twist angle. Each LC molecule of the plurality of LC molecules 620 is an elongated, rod-like molecule with a dipole moment along the axis of the molecule. In one or more examples, each of the plurality of LC molecules 620 has a size of a few nanometers and includes both rigid and flexible parts allowing for orientational and positional order. The plurality of LC molecules may exhibit optical birefringence depending on external conditions such as an external field (e.g., an applied voltage). Generally, in a Pi cell, when the electric field is switched off (e.g., the application of 0 V) the LC molecules 620 experience a torque which causes an electro-optical response of the Pi cell. Thus, the modulation of an external field to a LC cell (e.g., LC cell 605a or LC cell 605b) may result in modification of the optical birefringence of that LC cell. It shall be understood that although LC cells 605a and 605b are described as Pi cells in the example of FIG. 6, LC cells 605a and 605b (and also any of the LC cells shown and described with respect to FIGS. 7-10) may be any type of LC cell, including Pi cell (parallel rubbing), anti-parallel, twisted-nematic (TN), Ferroelectric, any other type of LC cell known in the art, or any combination thereof, and that the disclosure is not limited in this respect.

Each of LC cells 605a and 605b are positioned between two optically transparent electrode layers. LC cell 605a is positioned between electrode layers 615a and 615b, and LC cell 605b is positioned between electrode layers 615c and 615d. Electrode layer 615a is applied on an output side of first, bottom substrate 610 and electrode layer 615d is applied on an input side of third, top substrate 614. Second, common substrate 612 includes an electrode layer on both an input and an output side; that is, electrode layer 615b is applied on an input side of second, common substrate 612 and electrode layer 615c is applied on an output side of second, common substrate 612. In this way, electrode layers 615a and 615b may be considered to be an electrode layer pair 615a/615b configured to apply a voltage to LC cell 605a, and electrode layers 615c and 615d may be considered to be an electrode layer pair 615c/615d configured to apply a voltage to LC cell 605b.

Substrates 610, 612, and 614 may comprise, for example, an optically transparent glass or plastic substrate material. Electrodes 615a, 615b, 615c, and 615d may comprise, for example, an optically transparent electrically conductive polymer, metal, or ceramic. In some embodiments, the optically transparent electrically conductive polymer, metal, or ceramic is indium tin oxide (ITO). In some examples, the substrates 610, 612, and 614 are isotropic and do not affect the polarization of broadband light as it passes through the substrate. In some examples, one or more of substrates 610, 612, and 614 may be anisotropic to act as a compensation film(s). The substrates 610, 612, and 614 and electrodes 615a, 615b, 615c, and 615d are configured such that substantially uniform electric fields are applied through the LC cells 605a and 605b. LC cell 605a and LC cell 605b are configured such that one of the LC cells is configured to drive the stacked LC structure 600 (i.e., control its total phase retardation) while the other acts as a compensation cell to improve the angular response of the stacked LC structure. As shown in FIG. 6, the LC cell 605a and 605b have anti-parallel rubbing direction which helps improve the viewing angle. Another reason to use dual cells, specifically in the example of twisted nematic liquid crystal cells, is that two cells are needed to change the right hand circularly polarized light to left and vice versa. In that example, both cells are driven simultaneously with the electric field such that one cell rotates the x-polarization and the other cell rotates the y-polarization. Yet another reason to use dual cells is that the stacked LC structure 600 using two cells may be considered to be dual twist in that the first cell 605a generates a twist from 0 degrees to 70 degrees and the second cell 605b generates a twist from 70 degrees down to 0 degrees with opposite handedness, which may help to achieve substantially uniform performance across the visible range of spectra.

Electrode layer pairs 615a/615b and 615c/615d are further coupled to a controller (e.g., processor(s) 302 of FIGS. 3 and 4 or SOC 530A, 530B, or 530C of FIG. 5) configured to apply a voltage to one or more of LC cells 615a and 615b, respectively. The application of a voltage to an electrode layer pair causes the formation of an electric field through the corresponding LC cell. In various examples, the generated electric field is proportional to the applied voltage. In some examples, the controller is configured to determine a failure in one of the LC cells (e.g., LC cell 605a or LC cell 605b) and adjust the voltage applied accordingly. For example, if the controller detects a failure in LC cell 605a, the controller may apply a voltage to LC cell 605b such that LC cell 605b drives the total phase retardation of the stacked LC structure 600.

Turning now to the propagation of light through stacked LC structure 600, incident light 640 is transmitted into LC cell 605a via the first, bottom substrate 610a. As the light 640 propagates through the LC cell 605a, polarizations of the light 640 corresponding to the ordinary and extraordinary axis of the LC cell 605a take different paths through the LC cell 605a. An amount of phase adjustment occurs based at least in part on the ordinary and extraordinary axis having different indices of refraction. Thus, LC cell 605a applies a first amount of phase adjustment to the light 640 as it propagates through LC cell 605a. Light 640 is transmitted into LC cell 605b via second, common substrate 612. LC cell 605b is configured to apply a second amount of phase adjustment to light 640. Light 640 exits the stacked LC structure 600, via third, top substrate 614, as transmitted light 650. Transmitted light 650 is light 640 after its phase is adjusted by a third amount wherein the third amount is representative of a total amount of phase adjustment applied by stacked LC structure 600. That is, the stacked LC structure 600 is configured to apply a third amount of phase adjustment to incident light 640. The third amount may not be a linear combination of the first and second amount. In some examples, transmitted light 650 is right hand circularly polarized (RCP), left hand circularly polarized (LCP), horizontally linearly polarized, vertically linearly polarized, or any combination thereof. In some embodiments, for example, stacked LC structure 600 rotates the polarization of LCP incident light such that the transmitted light is RCP or vice versa, in a first state, and transmits light unchanged in a second state.

In some examples, the total phase retardation of stacked LC structure 600 may be controllable or configurable through the application of a voltage to one or both LC cells 605a and/or 605b. In this way, the stacked LC structure may be considered to be “switchable” in that its light transmission (phase) characteristics may be changed or controlled based on an applied voltage. In other words, the stacked LC structure may be considered to be a switchable phase modulator element. In some examples, the total phase retardation of stacked LC structure 600 may be such that stacked LC structure 600 acts as a nominal quarter-wave plate, a nominal half-wave plate, or a nominal full-wave plate. As used herein, a “nominal” waveplate imparts a polarization change that is approximately that associated with the nominal waveplate structure for at least some wavelengths of incident light. The waveplate may not affect all wavelengths of light equally, even within a range over which the waveplate is designed to operate. Further, the waveplate may be designed to operate over a selected wavelength or range of wavelengths, which may be less than broadband light.

In some examples, stacked LC structure 600 is configurable via application of a control voltage to one or more of electrode layers 605a-605d by a respective controller, such as a controller of HMD 112, to be in a first optical state or a second optical state. In the first optical state, stacked LC structure 600 converts incident light of a first or second polarization into transmitted light of a second or first polarization, respectively. The first polarization is orthogonal to the second polarization. In the second optical state, stacked LC structure 600 transmits incident light without changing its polarization.

FIG. 7 illustrates an example stacked LC cell structure 700 that includes two LC cells 705a and 705b with anti-parallel alignment in accordance with some examples. Stacked LC cell structure 700 includes LC cell 705a, a LC cell 705b, a first, bottom substrate 710, a second, common substrate 712, and a third, top substrate 714. Each of the LC cells 705a and 705b includes a plurality of LC molecules 720.

Each of LC cells 705a and 705b are positioned between two optically transparent electrode layers. LC cell 705a is positioned between electrode layers 715a and 715b, and LC cell 705b is positioned between electrode layers 715c and 715d. Electrode layer 715a is applied on an output side of first, bottom substrate 710 and electrode layer 715d is applied on an input side of third, top substrate 714. Second, common substrate 712 includes an electrode layer on both sides; that is, electrode layer 715b is applied on an input side of second, common substrate 712 and electrode layer 715c is applied on an output side of second, common substrate 712. In this way, electrode layers 715a and 715b may be considered to be an electrode layer pair 715a/715b configured to apply a voltage to LC cell 705a, and electrode layers 715c and 715d may be considered to be an electrode layer pair 715c/715d configured to apply a voltage to LC cell 705b.

Turning now to the propagation of light through stacked LC structure 700, incident light 740 is incident on first, bottom substrate 710a. Light 740 is transmitted into LC cell 705a via the first, bottom substrate 710a. LC cell 705a applies a first amount of phase adjustment to the light 740 as it propagates through LC cell 705a. Light 740 is transmitted into LC cell 705b via second, common substrate 712. LC cell 705b is configured to apply a second amount of phase adjustment to the light 740. Light 740 exits the stacked LC structure 600, via third, top substrate 714, as transmitted light 750. Transmitted light 750 is light 740 after its phase is adjusted by a third amount wherein the third amount is representative of a total amount of phase adjustment applied by stacked LC structure 700. The third amount may be not equal to a linear combination of the first amount and the second amount. In some examples, LC cell 705b may act as a compensation cell to improve the angular response of the stacked LC structure.

In some examples, the total phase retardation of stacked LC structure 700 may be controllable or configurable through the application of a voltage to one or both LC cells 705a and/or 705b. In this way, the stacked LC structure 700 may be considered to be “switchable” in that its light transmission characteristics may be changed or controlled based on an applied voltage. In some examples, he total phase retardation of stacked LC structure 700 may be such that stacked LC structure 700 acts as a quarter-wave plate, a half-wave plate, or a full-wave plate.

In some embodiments, stacked LC structure 700 is configurable via application of a control voltages to one or more of electrode layers 705a-705d by a respective controller, such as a controller of HMD 112, to be in a first optical state or a second optical state. In the first optical state, stacked LC structure 700 converts light of a first or second polarization into light of a second or first polarization, respectively. The first polarization is orthogonal to the second polarization. In the second optical state, stacked LC structure 700 transmits incident light without changing its polarization.

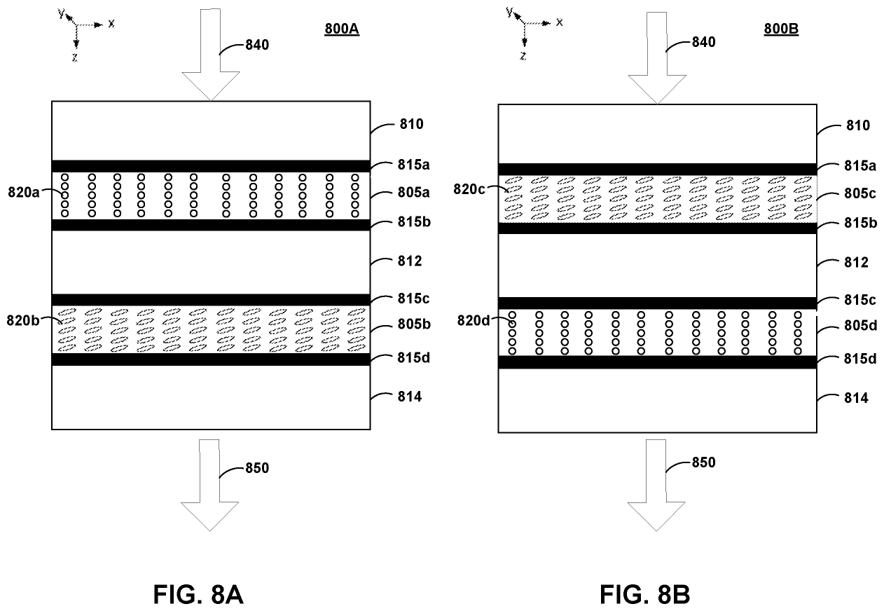

FIG. 8A illustrates an example stacked LC cell structure 800A that includes two LC cells 805a and 805b having perpendicular alignment in accordance with an embodiment. In a perpendicular alignment, the average molecular alignment of molecules 820a of LC cell 805a is orthogonal to the average molecular alignment of molecules 820b of LC cell 805b. In the example of FIG. 8A, each of the plurality of LC molecules 820a associated with LC cell 805a are oriented such their dipole moment are parallel to the y-axis in the absence of an electric field. On the other hand, the plurality of LC modules 820b associated with LC cell 805b are oriented such that their dipole moment is substantially parallel to that of molecules 820a. For example, the plurality of LC molecules 820b associated with LC cell 805b may be oriented such that their dipole moment not perpendicular or parallel to the X-Z plane in the absence of an electric field (e.g., their dipole moment is in a range between 0.5° and 89.5° to the X-Z plane in the absence of an electric field). In some example in which the LC cells 805a and 805b have a positive dielectric anisotropy, the plurality of LC molecules 820b make an angle in the range of 0.5° to 10° to the X-Z plane. In some examples in which LC cells 805a and 805b have negative dielectric anisotropy, the plurality of LC molecules 820 may make an angle in the range of 80° to 89.5° to the X-Z plane.

A birefringence of each of the plurality of LC molecules 820a and 820b is an intrinsic property of an LC molecule associated with the plurality of LC molecules 820a and 820b. That is, a birefringence of a LC molecule of the plurality of LC molecules 820a or 820b is not related to its orientation. In various examples, a phase retardation experienced by a light propagating through LC cell 805a and 805b is related to the orientation of the plurality of the LC molecules 820a and 820b, respectively. For example, in examples including LC cells 805a and 805b with a positive dielectric anisotropy, the retardation decreases with an increased tilt angle of molecules 820a and 820b. In some other examples including LC cells 805a and 805b with a negative dielectric anisotropy, the phase retardation experienced by a light passing through LC cells 805a and 805b increases with a decreased tilt angle. In the example of FIG. 8A, an electric field applied to LC cell 805b by electrode layer pair 815a/815b may be oriented anti-parallel to an electric field applied to LC cell 805a by electrode layer pair 815c/815d. For example, electrode layer pair 815a/815b may be configured to generate a uniform electric field oriented anti-parallel to the z axis through LC cell 805a, and electrode layer pair 815c/815d may be configured to generate a uniform electric field oriented anti-parallel to the electric field through the LC cell 805a.

Turning now to the propagation of light through stacked LC structure 800, incident light 840 is incident on first, bottom substrate 810a. Light 840 is transmitted into LC cell 805a via the first, bottom substrate 810a. As the light 840 propagates through the LC cell 805a, polarizations of the light 840 corresponding to the ordinary and extraordinary axis of the LC cell 805a take different paths through the LC cell 805a. An amount of phase adjustment occurs based at least in part on the ordinary and extraordinary axes having different indices of refraction. Thus, LC cell 805a applies a first amount of phase adjustment to the light 840 as it propagates through LC cell 805a. Light 840 is transmitted into LC cell 805b via second, common substrate 812. LC cell 805b is configured to apply a second amount of phase adjustment to the light 840. Light 840 exits the stacked LC structure 800, via third, top substrate 814, as transmitted light 850. Transmitted light 850 is light 840 after its phase is adjusted by a third amount wherein the third amount is representative of a total amount of phase adjustment applied by stacked LC structure 800, and wherein the third amount may be not equal to a linear combination of the first amount and the second amount. In some examples, LC cell 805b may be utilized as a backup cell for driving the system. For example, in examples in which the LC cell 805a is used to drive the total phase retardation of the stacked LC structure 800 and a failure is detected in LC cell 805a, the LC cell 805b may operate as the driving cell instead.

FIG. 8B illustrates an alternative example stacked LC structure 800B in accordance with some embodiments. Stacked LC structure 800B includes a first LC cell 805a and a second LC cell 805d. Molecules 820c of LC cell 805c are oriented substantially perpendicular as compared to molecules 820a of LC cell 805a, and molecules 820d of LC cell 805d are oriented substantially perpendicular as compared to molecules 820b of LC cell 805b.

In some examples, the total phase retardation of stacked LC structures 800A and 800B may be controllable or configurable through the application of a voltage to one or both LC cells 805a and/or 805b (for stacked LC structure 800A), and to one or both LC cells 805c and/or 805d (for stacked LC structure 800B). In this way, the stacked LC structure 800A and 800B may be considered to be “switchable” in that their light transmission characteristics may be changed or controlled based on an applied voltage. In some examples, he total phase retardation of stacked LC structures 800A and/or 800B may be such that stacked LC structures 800A and/or 800B act as a quarter-wave plate, a half-wave plate, or a full-wave plate.

In some examples, stacked LC structures 800A and 800B are configurable via application of a control voltages to one or more of electrode layers 805a-805d by a respective controller, such as a controller of HMD 112, to be in a first optical state or a second optical state. In the first optical state, stacked LC structure 800A and/or 800b converts light of a first or second polarization into light of a second or first polarization, respectively. The first polarization is orthogonal to the second polarization. In the second optical state, stacked LC structure 800A and/or 800B transmits incident light without changing its polarization.

As discussed above with respect to FIG. 6, a stacked LC structure (such as stacked LC structure 700 as shown in FIG. 7, and/or stacked LC structures 800A/800B as shown in FIG. 8) include a common substrate (such as common substrates 712 and/or 812) having a first electrode on an input side of the common substrate and a second electrode on an output side of the common substrate, in accordance with the techniques described herein. This results in the stacked LC structures omitting a substrate layer that would otherwise be present between the first and second LC cells, allowing reduced thickness of the overall stacked LC structure. This may reduce a size and a weight of an optical assembly in which the stacked LC structure is used, which is an important consideration for user comfort of a head-mounted display. The reduced thickness achieved by eliminating a substrate layer in a stacked LC structure may be even more apparent when multiple stacked LC structures are used in successive optical stages to provide a varifocal optical display assembly having adjustable optical power.

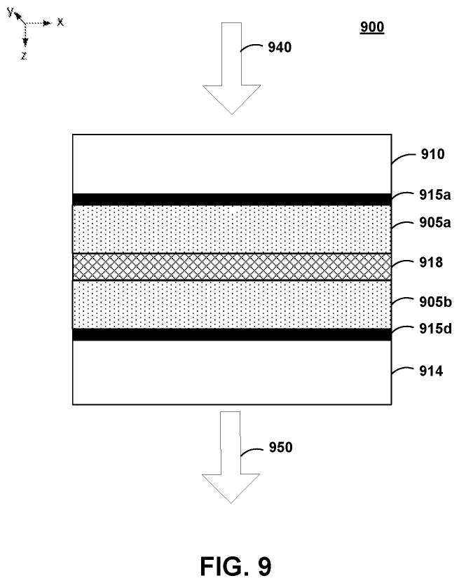

In some examples, rather than including a common substrate having electrodes on the input side and output side, a stacked LC structure may include a common electrode layer between two LC cells, with no additional substrate between the LC cells. FIG. 9 illustrates an example stacked LC structure 900 having a common electrode layer 918. Stacked LC structure 900 includes two LC cells 905a and 905b, a bottom substrate 910, common electrode layer 918, and a top substrate 914. In this example, each of LC cells 905a and LC cell 905b may be any type of LC cell as described herein or as known to those of skill in the art. In other examples, a stacked LC structure includes at least two LC cells arranged in optical series that share a common electrode layer between adjacent LC cells. Therefore, although a stacked LC structure including two LC cells is shown and described with respect to FIG. 9 for purposes of illustration, it shall be understood that the disclosure is not limited in this respect, and that stacked LC structure(s) may include a plurality of LC cells with a corresponding plurality of common electrode layers interspersed between adjacent LC cells.

In accordance with the techniques of the present description, stacked LC structure 900 substitutes common electrode layer 918 for a common substrate having electrodes on both the input and output surfaces, such as substrates 612, 712, and 812 as shown in FIGS. 6, 7, and 8A and 8B, respectively. As a result, in stacked LC structure 900, LC cell 905a is positioned between electrode layer 915a and common electrode 918, and LC cell 905b is positioned between electrode layer 915d and common electrode layer 918. In this way, electrode layer 915a and common electrode 918 may be considered to be an electrode layer pair 915a/918 configured to apply a voltage to LC cell 905a, and electrode layers 915d and common electrode 918 may be considered to be an electrode layer pair 915d/918 configured to apply a voltage to LC cell 905b.

In some embodiments, common electrode layer 918 may include an optically transparent electrically conductive polymer. For example, the optically transparent electrically conductive polymer may be poly(3,4-ethylenedioxythiophene):polystyrene sulfonate (PEDOT:PSS). In some examples, a common electrode layer 918 that includes PEDOT:PSS may be treated with one or more compounds to affect its electrical conductivity. For examples, a PEDOT:PSS layer may be treated with ethylene glycol, dimethyl sulfoxide (DMSO), a salt, a cosolvent, an alcohol such as polyvinyl alcohol (PVA), carbon nanotubes, silver nanowires or particles, or the like to affect its electrical conductivity. Common electrode layer 918 may be formed using any suitable technique, including spin coating and drying. By including a common electrode layer 918 instead of a common substrate and two electrodes, stacked LC structure 900 may further have a further reduced thickness than some stacked LC cells. Further, PEDOT:PSS may have a higher electrical conductivity that ITO when properly prepared and treated.

Substrates 910 and 914 may include, for example, an optically transparent glass or plastic substrate material. Electrode layers 915a and 915d may comprise, for example, an optically transparent electrically conductive material. In some embodiments, the optically transparent electrically conductive material is indium tin oxide (ITO). In some examples, the substrates 610 and 614 are isotropic and do not affect the polarization of broadband light as it passes through the substrate.

Incident light 940 is transmitted into LC cell 905a via bottom substrate 910a. LC cell 905a applies a first amount of phase adjustment to the light 940 as it propagates through LC cell 905a. Light 940 is transmitted through common electrode layer 918 into LC cell 905b. LC cell 905b is configured to apply a second amount of phase adjustment to light 940. Light 940 exits the stacked LC structure 900, via top substrate 914, as transmitted light 950.

In some examples, the total phase retardation of stacked LC structure 900 may be controllable or configurable through the application of a voltage to one or both LC cells 905a and/or 905b. In this way, the stacked LC structure may be considered to be “switchable” in that its light transmission characteristics may be changed or controlled based on an applied voltage. In some examples, the total phase retardation of stacked LC structure 900 may be such that stacked LC structure 900 acts as a quarter-wave plate, a half-wave plate, or a full-wave plate.

In some examples, stacked LC structure 900 is configurable via application of a control voltage to one or more of electrode layers 905a, 905d, and/or 918 by a respective controller, such as a controller of HMD 112, to be in a first optical state or a second optical state. In the first optical state, stacked LC structure 900 converts incident light of a first or second polarization into transmitted light of a second or first polarization, respectively. The first polarization is orthogonal to the second polarization. In the second optical state, stacked LC structure 900 transmits incident light without changing its polarization.

A stacked LC structure (such as stacked LC structure 900 as shown in FIG. 9) including a common electrode (such as common electrode 918) and no middle or common substrates between adjacent LC cells in accordance with the techniques described herein omits two substrate layers that would otherwise be present between the first and second LC cells, allowing further reduced thickness of the overall stacked LC structure. This may reduce a size and a weight of an optical assembly in which the stacked LC structure is used, which is an important consideration for user comfort of a head-mounted display. The reduced thickness achieved by eliminating two substrate layers in a stacked LC structure may be even more apparent when multiple stacked LC structures are used in successive optical stages to provide a varifocal optical display assembly having adjustable optical power.

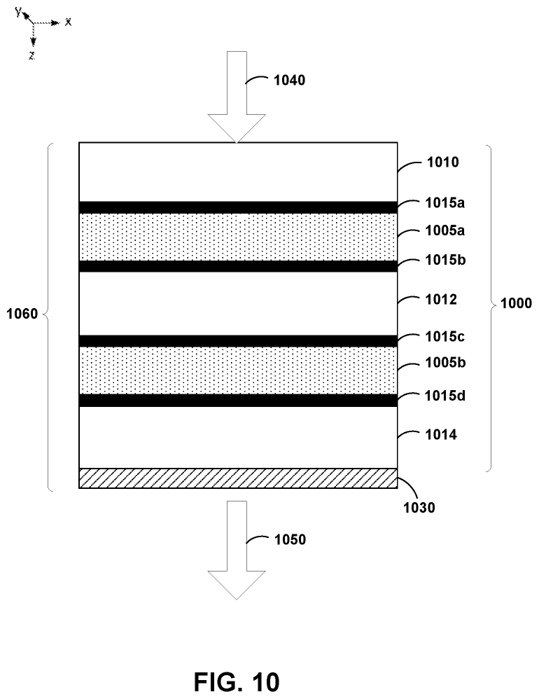

In some examples, further thickness reduction of a varifocal optical system may be achieved by incorporating a liquid crystal optical element directly on the top substrate, e.g., top substrate 914. This may enable omission of another substrate on which the liquid crystal optical element would otherwise be formed. FIG. 10 illustrates an example stacked LC structure 1000 in combination with an optical element 1030 in accordance with some examples. Although stacked LC structure 1000 of FIG. 10 is shown as a 3-substrate stacked LC structure such as any of those shown and described with respect to FIGS. 6-8, it shall be understood that a 2-substrate stacked LC structure such as that shown and described with respect to FIG. 9 may be substituted for 3-substrate stacked LC structure 1000, and that the disclosure is not limited in this respect.

Stacked LC cell structure 1000 includes a LC cell 1005a, a LC cell 1005b, a first, bottom substrate 1010, a second, common substrate 1012, and a third, top substrate 1014. Each of LC cells 1005a and 1005b comprises a plurality of LC molecules (not shown in detail in FIG. 10).

In accordance with the techniques of the present description, each of LC cells 1005a and 1005b are positioned between two optically transparent electrode layers 1015a and 1015b, and 1015c and 1015d, respectively. Electrode layer 1015a is applied on an output side of first, bottom substrate 1010 and electrode layer 1015d is applied on an input side of third, top substrate 1014. Second, common substrate 1012 includes an electrode layer on both sides; that is, electrode layer 1015b is applied on an input side of second, common substrate 1012 and electrode layer 1015c is applied on an output side of second, common substrate 1012. In this way, electrode layers 1015a and 1015b may be considered to be an electrode layer pair 1015a/1015b configured to apply a voltage to LC cell 1005a, and electrode layers 1015c and 1015d may be considered to be an electrode layer pair 1015c/1015d configured to apply a voltage to LC cell 1005b.

Turning now to the propagation of light through stacked LC structure 1000, incident light 1040 is incident on first, bottom substrate 1010a. Light 1040 is transmitted into LC cell 1005a via the first, bottom substrate 1010a. As the light 1040 propagates through the LC cell 1005a, polarizations of the light 1040 corresponding to the ordinary and extraordinary axis of the LC cell 1005a take different paths through LC cell 1005a. An amount of phase adjustment occurs based at least in part on the ordinary and extraordinary axis having different indices of refraction. Thus, LC cell 1005a applies a first amount of phase adjustment to the light 1040 as it propagates through LC cell 1005a. Light 1040 is transmitted into LC cell 1005b via second, common substrate 1012. LC cell 1005b is configured to apply a second amount of phase adjustment to the light 1040. Light 1040 exits the stacked LC structure 1000, via third, top substrate 1014, as transmitted light 1050. Transmitted light 1050 is light 1040 after its phase is adjusted by a third amount wherein the third amount is representative of a total amount of phase adjustment applied by stacked LC structure 1000, and wherein the third amount may be not equal to a linear combination of the first amount and the second amount.

In some examples, stacked LC structure 1000 is configurable via application of a control voltage to one or more of electrode layers 1005a-1005d by a respective controller, such as a controller of HMD 112, to be in a first optical state or a second optical state. In the first optical state, stacked LC structure 1000 converts light of a first or second polarization into light of a second or first polarization, respectively. The first polarization may be orthogonal to the second polarization. In the second optical state, stacked LC structure 100 transmits incident light without changing its polarization.

In some examples, stacked LC structure 1000 and optical element 1030 form a pair of optical elements corresponding to an optical stage 1060, e.g., of a varifocal optical system. Stacked LC structure 1000 is configurable via a respective controller (e.g., via application of a control voltage of one or more of electrode layers 1015a-1015d) to be in a first optical state (e.g., an “off” state) or a second optical state (e.g., an “on” state). In the first optical state, stacked LC structure 1000 is configured to convert incident light to transmitted light having a different polarization from that of the incident light. In the second optical state, stacked LC structure 1000 is configured to transmit incident light without changing its polarization. For example, when stacked LC structure 1000 is set to the first state, left circularly polarized (LCP) light incident upon stacked LC structure 1000 will be transmitted as right circularly polarized (RCP) light, and vice versa. In contrast, when stacked LC structure 1000 is set to the second state, incident light upon stacked LC structure 1000 will be transmitted without a change in its polarization (e.g., LCP light remains LCP and RCP light remains RCP). In some embodiments, stacked LC structure 1000 may be considered a switchable retarder or switchable wave plate, such as a switchable half-wave plate.

Optical element 1030 may be an optical element that exhibits a first optical power for light of a first polarization and a second optical power, different from the first optical power, for light of a second polarization that is orthogonal to the first polarization. In some examples, optical element 1030 is a Pancharatnam-Berry Phase (PBP) lens. A PBP lens may be an active PBP lens or a passive PBP lens. A passive PBP lens has two optical states, an additive state and a subtractive state. The state of a passive PBP liquid crystal lens is determined by the handedness of polarization of light incident on the passive PBP liquid crystal lens. A passive PBP liquid crystal lens operates in a subtractive state (negative focal power) responsive to incident light with a first circular polarization (e.g., RCP) and operates in an additive state (positive optical power) responsive to incident light with a second circular polarization (e.g., LCP). Note that the passive PBP liquid crystal lens outputs light that has a handedness opposite that of the light input into the passive PBP liquid crystal lens. For a passive PBP lens, e.g., incident light that is RCP is output LCP and incident light that is LCP is output RCP.

An active PBP lens has three optical states: an additive state, a neutral state, and a subtractive state. The additive state adds optical power to the system, the neutral state does not affect the optical power of the system (and does not affect the polarization of light passing through the active PBP lens), and the subtractive state subtracts optical power from the system. The state of an active PBP liquid crystal lens is determined by the handedness of polarization of light incident on the active PBP lens and a voltage applied to the PBP lens. An active PBP lens operates in a subtractive state responsive to incident light with a first circular polarization (e.g., RCP) and an applied voltage below some threshold value, operates in an additive state responsive to incident light with a second, orthogonal circular polarization (e.g., LCP) and an applied voltage of less than the threshold value, and operates in a neutral state (regardless of polarization) responsive to an applied voltage larger than the threshold voltage, which aligns liquid crystals with positive dielectric anisotropy along with the electric field direction. Note that if the active PBP liquid crystal lens is in the additive or subtractive state, light output from the active PBP lens has a handedness opposite that of the light input into the active PBP lens. In contrast, if the active PBP lens is in the neutral state, light output from the active PBP lens has the same handedness as the light input into the active PBP lens. Further details regarding PBP liquid crystal lenses are described in U.S. Pat. No. 10,151,961, filed Dec. 29, 2016, which is incorporated herein by reference in its entirety.

In some embodiments, optical element 1030 includes a thin film formed on a surface of stacked LC structure 1000. For example, optical element 1030 may be a coating or a thin film that is deposited on a surface of stacked LC structure 1000, such as on an output side of third, top substrate 1014. For example, optical element 1030 may be formed by forming an alignment layer on the output side of third, top substrate 1014 then coating the alignment layer with a liquid crystal layer that forms optical element 1030. As another example, optical element 1030 may be formed by forming an first optically transparent electrode on output side of third, top substrate 1014, forming an first alignment layer on the optically transparent electrode, forming a liquid crystal layer on the first alignment layer, forming a second alignment layer on the liquid crystal layer, and forming a second optically transparent electrode on the second alignment layer.

In some examples, rather than forming optical element 1030 directly on third, top substrate 1014, optical element 1030 may be formed on a separate substrate, removed from the separate substrate, and joined to third, top substrate 1014, e.g., using an optically transparent adhesive. Such a technique may allow omission of at least one of the alignment layers, which may further reduce a thickness of stacked LC structure 1000.

Two or more optical stages, such as two or more optical stages 1060, may be arranged in optical series to provide a varifocal optical assembly in accordance with some embodiments. Each optical stage may include a stacked LC structure as described herein and a lens, such as a PBP lens, with a selected focal power. Control electronics of the HMD, such as processor(s) 302 of FIGS. 3 and 4 or SOCs 530A, 530B, and/or 530C of FIG. 5 may control voltages applied to the stacked LC structure and, optionally, the PBP lens (in examples in which the PBP lens is active) to control a focal power of the optical stage to be positive, negative or 0 based on the handedness of the light incident to the PBP lens and voltage applied to the PBP lens (in examples in which the PBP lens is active). By combining a plurality of optical stages having different optical powers, a varifocal optical assembly may be generated with a plurality of effective optical powers, depending on the optical powers of the individual optical stages and the number of optical stages.

An optical stage (such as optical stage 1060) including a stacked LC structure (such as stacked LC structure 600 as shown in FIG. 6, stacked LC structure 700 as shown in FIG. 7, stacked LC structures, 800A/800B as shown in FIG. 8, and/or stacked LC structure 1000 as shown in FIG. 10) comprising a common substrate (such as common substrates 612, 712 and/or 812) having a first electrode on an input side of the common substrate and a second electrode on an output side of the common substrate, or a stacked LC structure (such as stacked LC structure 900 as shown in FIG. 9) having a common electrode (such as common electrode 918), in accordance with the techniques described herein, results in an optical stage that omits one or more substrate layers that would otherwise be present between adjacent LC cells in a stacked LC structure, allowing reduced thickness of the overall stacked LC structure and thus reduced thickness of the overall optical stage. This may reduce a size and a weight of an optical assembly in which the stacked LC structure/optical stage is used, which is an important consideration for user comfort of a head-mounted display. The reduced thickness achieved by eliminating one or more substrate layers in a stacked LC structure and corresponding optical stage may be even more apparent when multiple stacked LC structures are used in successive optical stages to provide a varifocal optical display assembly having adjustable optical power.

It shall be understood that the designs presented herein are merely illustrative, and other designs of stacked LC structures may be generated using the principles described herein. Persons skilled in the relevant art can appreciate that many modifications and variations are possible considering the above disclosure.

As described by way of various examples herein, the techniques of the disclosure may include or be implemented in conjunction with an artificial reality system. As described, artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted device (HMD) connected to a host computer system, a standalone HMD, a mobile device or computing system, or any other hardware platform capable of providing artificial reality content to one or more viewers.

The techniques described in this disclosure may be implemented, at least in part, in hardware, software, firmware or any combination thereof. For example, various aspects of the described techniques may be implemented within one or more processors, including one or more microprocessors, DSPs, application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

As described by way of various examples herein, the techniques of the disclosure may include or be implemented in conjunction with an artificial reality system. As described, artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head mounted device (HMD) connected to a host computer system, a standalone HMD, a mobile device or computing system, or any other hardware platform capable of providing artificial reality content to one or more viewers.

### Examples

Example 1. A stacked liquid crystal (LC) structure comprising: a bottom substrate; a common substrate; a top substrate; a first LC cell disposed between the bottom substrate and the common substrate; a second LC cell disposed between the common substrate and the top substrate, wherein the common substrate includes or is coated with at least one electrically conductive layer that acts as an electrode for at least one of the two LC cells, wherein the stacked LC structure is configurable to be in a first state or a second state, wherein in the first state, the stacked LC structure converts incident light of a first polarization into light of a second polarization; and in the second state, the stacked LC structure transmits incident light without changing polarization of the incident light.

Example 2. The stacked LC structure of Example 1, wherein the common substrate includes an input surface and an output surface, wherein the common substrate includes a first electrically conductive layer disposed on the input surface that acts as an electrode for the first LC cell, and a second electrically conductive layer disposed on the output surface that acts as an electrode for the second LC cell.

Example 3. The stacked LC structure of Example 2, wherein the bottom substrate includes a third electrically conductive layer adjacent to the first LC cell and the top substrate includes a fourth electrically conductive layer adjacent to the second LC cell, and wherein the first and third electrically conductive layers act as an electrode pair for the first LC cell and the second and fourth electrically conductive layers as an electrode pair for the second LC cell.

Example 4. The stacked LC structure of Example 1, wherein the stacked LC structure is configurable to be in the first state or the second state by application of a voltage to the at least one electrically conductive layer.

Example 5. The stacked LC structure of Example 1, wherein the first state is associated with application of a first voltage to the at least one electrically conductive layer and the second state is associated with application of a second voltage to the at least one electrically conductive layer, wherein the first voltage is different than the second voltage.

Example 6. The stacked LC structure of Example 5, wherein the first voltage is substantially equal to zero.

Example 7. The stacked LC structure of Example 1, wherein the light of the first polarization is right circularly polarized light and the light of the second polarization is left hand circularly polarized light.

Example 8. The stacked LC structure of Example 1, wherein the electrically conductive layer is an optically transparent electrically conductive polymer.

Example 9. The stacked LC structure of Example 1, wherein the optically transparent electrically conductive polymer is poly(3,4-ethylenedioxythiophene):polystyrene sulfonate (PEDOT:PSS), and wherein the substrate is not coated with a separate electrically conductive layer.

Example 10. The stacked LC structure of Example 1, wherein in the first state the stacked LC structure functions as one of a nominal quarter-wave plate or a nominal half-wave plate.

Example 11. The stacked LC structure of Example 1, further comprising an optical element on an output surface of the top substrate, wherein behavior of the optical element depends on polarization of light incident on the optical element.

Example 12. A stacked liquid crystal (LC) structure comprising a bottom substrate; a top substrate; a common electrically conductive layer; a first LC cell disposed between an output surface of the bottom substrate and the common electrically conductive layer; and a second LC cell disposed between an input surface of the top substrate and the common electrically conductive layer; wherein the stacked LC structure is configurable to be in a first state or a second state, and wherein in the first state, the stacked LC structure converts incident light of a first polarization into light of a second polarization; and in the second state, the stacked LC structure transmits incident light without changing polarization of the incident light.

Example 13. The stacked LC structure of Example 12, wherein the common electrically conductive layer acts as an electrode for the first LC cell and the second LC cell.

Example 14. The stacked LC structure of Example 13, wherein the bottom substrate includes a first electrically conductive layer adjacent to the first LC cell and the top substrate includes a second electrically conductive layer adjacent to the second LC cell, and wherein the first electrically conductive layer and the common electrically conductive layer act as an electrode pair for the first LC cell and the second electrically conductive layer and the common electrically conductive layer act as an electrode pair for the second LC cell.

Example 15. The stacked LC structure of Example 12, wherein the stacked LC structure is configurable to be in the first state or the second state by application of a voltage to the common electrically conductive layer.

Example 16. The stacked LC structure of Example 12, wherein the common electrically conductive layer comprising an electrically conductive polymer.

Example 17. The stacked LC structure of Example 12, further comprising an optical element on an output surface of the top substrate, wherein behavior of the optical element depends on polarization of light incident on the optical element.

Example 18. A head mounted display comprising a display configured to emit image light; and an optical assembly configured to transmit the image light, wherein the optical assembly comprises a stacked liquid crystal (LC) structure comprising: a bottom substrate; a common substrate; a top substrate; a first LC cell disposed between the bottom substrate and the common substrate; a second LC cell disposed between the common substrate and the top substrate, wherein the common substrate includes or is coated with at least one electrically conductive layer that acts as an electrode for at least one of the two LC cells, wherein the stacked LC structure is configurable to be in a first state or a second state, wherein: in the first state, the stacked LC structure converts incident light of a first polarization into light of a second polarization; and in the second state, the stacked LC structure transmits incident light without changing polarization of the incident light.

Example 19. The head mounted display of Example 18, wherein the electrically conductive layer is an optically transparent electrically conductive polymer.

Example 20. The head mounted display of Example 18, wherein the stacked LC structure further comprises an optical element on an output surface of the top substrate, wherein behavior of the optical element depends on polarization of light incident on the optical element.

Various examples have been described. These and other examples are within the scope of the following claims.

1. (canceled)

2. (canceled)

3. (canceled)

4. (canceled)

5. The stacked LC structure of claim 12, wherein the first state is associated with application of a first voltage to the common electrically conductive layer and the second state is associated with application of a second voltage to the common electrically conductive layer, wherein the first voltage is different than the second voltage.

6. The stacked LC structure of claim 5, wherein the first voltage is substantially equal to zero.

7. The stacked LC structure of claim 12, wherein the light of the first polarization is right circularly polarized light and the light of the second polarization is left circularly polarized light.

8. The stacked LC structure of claim 12, wherein the common electrically conductive layer is an optically transparent electrically conductive polymer.

9. The stacked LC structure of claim 12, wherein the optically transparent electrically conductive polymer is poly(3,4-ethylenedioxythiophene):polystyrene sulfonate (PEDOT:PSS).

10. The stacked LC structure of claim 12, wherein in the first state the stacked LC structure functions as one of a nominal quarter-wave plate or a nominal half-wave plate.

11. (canceled)

12. A stacked liquid crystal (LC) structure comprising:
a bottom substrate;
a top substrate;
a common electrically conductive layer;
a first LC cell disposed between an output surface of the bottom substrate and the common electrically conductive layer; and
a second LC cell disposed between an input surface of the top substrate and the common electrically conductive layer;
wherein the common electrically conductive layer acts as an electrode for the first LC cell and the second LC cell,
wherein the stacked LC structure is configurable to be in a first state or a second state, and wherein:
in the first state, the stacked LC structure converts incident light of a first polarization into light of a second polarization; and
in the second state, the stacked LC structure transmits incident light without changing polarization of the incident light.

13. (canceled)

14. The stacked LC structure of claim 12, wherein the bottom substrate includes a first electrically conductive layer adjacent to the first LC cell and the top substrate includes a second electrically conductive layer adjacent to the second LC cell, and wherein the first electrically conductive layer and the common electrically conductive layer act as an electrode pair for the first LC cell and the second electrically conductive layer and the common electrically conductive layer act as an electrode pair for the second LC cell.

15. The stacked LC structure of claim 12, wherein the stacked LC structure is configurable to be in the first state or the second state by application of a voltage to the common electrically conductive layer.

16. The stacked LC structure of claim 12, wherein the common electrically conductive layer comprises an electrically conductive polymer.

17. The stacked LC structure of claim 12, further comprising an optical element on an output surface of the top substrate, wherein behavior of the optical element depends on polarization of light incident on the optical element.

18. A head mounted display comprising:
a display configured to emit image light; and
an optical assembly configured to transmit the image light, wherein the optical assembly comprises:
a stacked liquid crystal (LC) structure comprising:
a bottom substrate;
a common electrically conductive layer;
a top substrate;
a first LC cell disposed between the bottom substrate and the common substrate;
a second LC cell disposed between the common substrate and the top substrate,
wherein the common electrically conductive layer acts as an electrode for the first LC cell and the second LC cell,
wherein the stacked LC structure is configurable to be in a first state or a second state, wherein:
in the first state, the stacked LC structure converts incident light of a first polarization into light of a second polarization; and
in the second state, the stacked LC structure transmits incident light without changing polarization of the incident light.

19. The head mounted display of claim 18, wherein the common electrically conductive layer is an optically transparent electrically conductive polymer.

20. The head mounted display of claim 18, wherein the stacked LC structure further comprises an optical element on an output surface of the top substrate, wherein behavior of the optical element depends on polarization of light incident on the optical element.
